(19) United States
(12) Patent Application Publication
(10) Pub. No.: US 2020/0161735 A1
(43) Pub. Date: May 21, 2020

(54) METHOD OF PRODUCING WAVEGUIDE-TO-COAXIAL ADAPTER ARRAY, METHOD OF PRODUCING ANTENNA ARRAY, AND METHOD OF PRODUCING WAVEGUIDING DEVICE

(71) Applicants: Nidec Corporation, Kyoto (JP); WGR Co., Ltd., Kyoto-city (JP)

(72) Inventors: Hiroyuki Kamo, Kyoto (JP); Yosuke Sato, Kyoto (JP); Hideki Kirino, Kyoto-city (JP)

(21) Appl. No.: 16/689,220

(22) Filed: Nov. 20, 2019

(30) Foreign Application Priority Data
Nov. 21, 2018 (JP) 2018-218393

(51) Int. Cl. H01P 5/08; H01P 11/00; H01P 3/06; H01Q 13/02

(52) U.S. Cl. CPC H01P 5/08; H01Q 13/0283; H01P 3/06; H01P 11/005

(57) ABSTRACT

A method of producing a waveguide-to-coaxial adapter array includes applying solder paste to inner surfaces of throughholes of an electrical conductor, inserting coaxial connectors respectively in the throughholes from a first surface of the conductor so that cores of the throughholes respectively become located at the inner surfaces of the throughholes, inserting one or more fixtures including a flat surface in the throughholes from a second surface of the conductor that is opposite to the first surface, so that the flat surface of the fixture(s) contacts the cores of the coaxial connectors and that the cores of the coaxial connectors are held against the inner surfaces of the throughholes, connecting the cores of the coaxial connectors respectively to the inner surfaces of the throughholes by melting the solder paste, and disengaging the fixture(s) from the throughholes.

### CROSS REFERENCE TO RELATED APPLICATION

The present invention claims priority under 35 U.S.C. § 119 to Japanese Application No. 2018-218393 filed on Nov. 21, 2018, the entire contents of which are hereby incorporated herein by reference.

### FIELD OF THE INVENTION

The present disclosure relates to a method of producing a waveguide-to-coaxial adapter array, a method of producing an antenna array, and a method of producing a waveguiding device.

### BACKGROUND

An antenna array with input/output capabilities for independent signals to/from a plurality of antenna elements is useful in a wide range of fields, such as radar or other sensing, wireless communications, etc. Among others, an antenna array that includes a plurality of horns as antenna elements can be particularly useful because of having a wide frequency band and low loss. Each horn in the horn antenna array can be fed by a hollow waveguide or a coaxial cable. For example, the specification of GB No. 821150 discloses an example structure for connecting a hollow waveguide and a coaxial cable.

On the other hand, waveguides called waffle iron ridge waveguides (WRG) have recently been developed. For example, the specification of U.S. Pat. No. 8,779,995 and the specification of U.S. Pat. No. 8,803,638 and Mohamed Al Sharkawy and Ahmed A. Kishk, “Wideband Beam-Scanning Circularly Polarized Inclined Slots Using Ridge Gap Wave-guide”, IEEE ANTENNAS AND WIRELESS PROPAGATION LETTERS, VOL. 13, 2014, pp. 1187-1190 disclose examples of such waveguide structures. In the present specification, such waveguides are referred to as “ridge waveguides”. As for ridge waveguides, too, connection with coaxial cables has been contemplated. For example, the specification of U.S. Pat. No. 8,803,638 and Mohamed Al Sharkawy and Ahmed A. Kishk, “Wideband Beam-Scanning Circularly Polarized Inclined Slots Using Ridge Gap Waveguide”, IEEE ANTENNAS AND WIRELESS PROPAGATION LETTERS, VOL. 13, 2014, pp. 1187-1190 disclose examples of such structures.

### SUMMARY

Example embodiments of present disclosure provide techniques for relatively easily producing devices to be fed by one or more coaxial connectors.

A production method according to an example embodiment of the present disclosure is a method of producing a waveguide-to-coaxial adapter array including a plurality of waveguide-to-coaxial adapters arranged in a two-dimensional array. The waveguide-to-coaxial adapter array includes an electrical conductor including a first surface, a second surface opposite to the first surface, a plurality of throughholes extending from the first surface through to the second surface, to which a plurality of coaxial connectors each including a core are to be connected, and a plurality of electrically conductive rods protruding from the second surface and being provided around the plurality of throughholes. The production method includes applying solder paste to an inner surface of each of the plurality of throughholes, inserting the plurality of coaxial connectors respectively in the plurality of throughholes from the first surface of the electrical conductor, so that the cores of the plurality of coaxial connectors respectively become located at the inner surfaces of the plurality of throughholes, inserting one or more fixtures including a flat surface in the plurality of throughholes from the second surface of the electrical conductor, so that the flat surface of the one or more fixtures is in contact with the cores of the plurality of coaxial connectors and that the cores of the plurality of coaxial connectors are respectively held against the inner surfaces of the plurality of throughholes, connecting the cores of the plurality of coaxial connectors respectively to the inner surfaces of the plurality of throughholes by melting the solder paste applied to the inner surfaces of the plurality of throughholes, and disengaging the one or more fixtures from the inner surfaces of the plurality of throughholes after performing the connecting of the cores, to obtain the waveguide-to-coaxial adapter array.

A production method according to another example embodiment of the present disclosure is a method of producing a waveguiding device. The waveguiding device includes a first electrical conductor, a second electrical conductor, and a plurality of coaxial connectors. The second electrical conductor includes a first surface, a second surface opposite to the first surface, a plurality of throughholes extending from the first surface through to the second surface, a plurality of waveguides protruding from the second surface, and a plurality of electrically conductive rods protruding from the second surface and being provided around the plurality of throughholes and the plurality of waveguides. The second surface of the second electrical conductor is opposed to a surface of the first electrical conductor. The plurality of co-axial connectors are respectively connected to the plurality of throughholes of the second electrical conductor. Each of the plurality of coaxial connectors includes a core. Ends of the plurality of waveguides are respectively continuous with the inner surfaces of the plurality of throughholes. The production method includes applying solder paste to the ends of the plurality of waveguides, inserting the plurality of coaxial connectors respectively in the plurality of throughholes from the first surface of the second electrical conductor, so that the cores of the plurality of coaxial connectors respectively become located at the ends of the plurality of waveguides, inserting one or more fixtures including a flat surface in the plurality of throughholes from the second surface of the second electrical conductor, so that the flat surface of the one or more fixtures is in contact with the cores of the plurality of coaxial connectors and that the cores of the plurality of coaxial connectors are respectively held against the ends of the plurality of waveguides, connecting the cores of the plurality of coaxial connectors respectively to the ends of the plurality of waveguides by melting the solder paste applied to the ends of the plurality of waveguides, and disengaging the one or more fixtures from the ends of the plurality of waveguides after the connecting of the cores, to obtain the second electrical conductor.

According to example embodiments of the present disclosure, devices to be fed by one or more coaxial connectors are able to be relatively easily produced.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1A is a diagram showing a waveguide-to-coaxial adapter array according to a first example embodiment of the present disclosure.

FIG. 1B is a diagram showing a construction resulting after removing coaxial connectors from the waveguide-to-coaxial adapter array shown in FIG. 1A.

FIG. 1C is a perspective view showing the structure of a throughhole 325 according to an example embodiment of the present disclosure.

FIG. 1D is a diagram showing the opening shape of the throughhole 325.

FIG. 2A is a perspective view showing a fixture according to the first example embodiment.

FIG. 2B is a perspective view showing the opposite-side structure of the fixture shown in FIG. 2A.

FIG. 3 is a flowchart showing a production method according to the first example embodiment.

FIG. 4 is a plan view showing a plurality of fixtures being inserted in a plurality of throughholes of a conductive member according to the first example embodiment.

FIG. 5 is a plan view showing a variant of the first example embodiment.

FIG. 6 is a perspective view showing a fixture according to variant of the first example embodiment.

FIG. 7A is a perspective view showing an exemplary antenna array including a waveguide-to-coaxial adapter array and a horn array.

FIG. 7B is a perspective view showing the antenna array of FIG. 7A as seen from a different perspective.

FIG. 8A is a perspective view showing a horn array according to an example embodiment of the present disclosure.

FIG. 8B is a plan view showing a horn array according to an example embodiment of the present disclosure.

FIG. 8C is a perspective view showing the structure of one horn according to an example embodiment of the present disclosure.

FIG. 8D is a diagram showing the opening shape of one horn according to an example embodiment of the present disclosure.

FIG. 8E is a diagram showing the structure of the horn array of FIG. 8A on the rear side.

FIG. 9 is a side view of an antenna array according to an example embodiment of the present disclosure.

FIG. 10 is a cross-sectional view of the antenna array in FIG. 9 as taken along line A-A′.

FIG. 11 is a cross-sectional view of the antenna array in FIG. 10 as taken along line B-B′.

FIG. 12 is a schematic diagram of a conductive member according to an example embodiment of the present disclosure as viewed from the rear side.

FIG. 13 is a diagram schematically showing an exemplary construction of a communication system that includes an antenna array and a communication device according to an example embodiment of the present disclosure.

FIG. 14A is a perspective view showing an exemplary construction of a waveguiding device according to a second example embodiment of the present disclosure.

FIG. 14B is a perspective view of structure remaining after removing a first conductive member from the waveguiding device shown in FIG. 14A.

FIG. 14C is a perspective view showing the opposite-side structure of a second conductive member shown in FIG. 14B.

FIG. 14D is a diagram showing enlarged the structure on the second conductive member shown in FIG. 14B.

FIG. 15A is a perspective view showing a fixture according to the second example embodiment.

FIG. 15B is a diagram showing the opposite-side structure of the fixture shown in FIG. 15A.

FIG. 16 is a diagram showing enlarged a site at which the fixture according to the second example embodiment is to be inserted.

FIG. 17 a cross-sectional view of a coaxial connector, a fixture, a throughhole, and the end of a ridge according to an example embodiment of the present disclosure.

FIG. 18 is a diagram showing a variant of the fixture according to the second example embodiment.

FIG. 19 is a perspective view schematically showing a non-limiting example of a fundamental construction of a waveguiding device according to an example embodiment of the present disclosure.

FIG. 20A is a diagram schematically showing a cross-sectional construction of a waveguiding device 100 according to an example embodiment of the present disclosure as taken in parallel to the XZ plane.

FIG. 20B is a diagram schematically showing another cross-sectional construction of the waveguiding device 100 as taken in parallel to the XZ plane.

FIG. 21 is a perspective view schematically showing the waveguiding device 100, illustrated so that the spacing between a conductive member 110 and a conductive member 120 is exaggerated for ease of understanding.

FIG. 22 is a diagram showing an exemplary range of dimension of each member in the structure shown in FIG. 20A.

FIG. 23A is a cross-sectional view showing an exemplary structure in which only a waveguide face 122a (which is an upper face) of the waveguide 122 according to an example embodiment of the present disclosure is electrically conductive, while any portion of the waveguide 122 other than the waveguide face 122a is not electrically conductive.

FIG. 23B is a diagram showing a variant in which the waveguide 122 is not formed on the conductive member 120.

FIG. 23C is a diagram showing an exemplary structure where the conductive member 120, the waveguide 122, and each of the plurality of conductive rods 124 are composed of a dielectric surface that is coated with an electrically conductive material such as a metal.

FIG. 23D is a diagram showing an exemplary structure in which dielectric layers 110b and 120b are provided on the outermost surface of the conductive members 110 and 120, the waveguide 122, and each of the conductive rods 124.

FIG. 23E is a diagram showing another exemplary structure in which dielectric layers 110b and 120b are provided on the outermost surface of the conductive members 110 and 120, the waveguide 122, and each of the conductive rods 124.

FIG. 23F is a diagram showing an example where the height of the waveguide 122 is lower than the height of the conductive rods 124, and the portion of the conductive surface 110a of the conductive member 110 that is opposed to the waveguide face 122a protrudes toward the waveguide 122.

FIG. 23G is a diagram showing an example where, further in the structure of FIG. 23F, portions of the conductive surface 110a that are opposed to the conductive rods 124 protrude toward the conductive rods 124.

FIG. 24A is a diagram showing an example where a conductive surface of the conductive member 110 is shaped as a curved surface.

FIG. 24B is a diagram showing an example where also a conductive surface 120a of the conductive member 120 is shaped as a curved surface.

FIG. 25A is a diagram schematically showing an electromagnetic wave that propagates in a narrow space, i.e., a gap between the waveguide face 122a of the waveguide 122 and the conductive surface 110a of the conductive member 110.

FIG. 25B is a diagram schematically showing a cross section of a hollow waveguide according to an example embodiment of the present disclosure.

FIG. 25C is a cross-sectional view showing an implementation where two waveguides 122 are provided on the conductive member 120.

FIG. 25D is a diagram schematically showing a cross section of a waveguiding device in which two hollow waveguides are placed side-by-side.

FIG. 26A is a perspective view schematically showing a portion of the construction of a slot antenna array 200 utilizing a WRG structure.

FIG. 26B is a diagram schematically showing a portion of a cross-sectional construction as taken parallel to an XZ plane which passes through the centers of two adjacent slots 112 along the X direction of the slot antenna array 200.

FIG. 27 is a perspective view schematically showing a portion of the construction of a slot antenna array 300 according to an example embodiment of the present disclosure.

FIG. 28A is a plan view showing a portion of the construction of the slot antenna array 300.

FIG. 28B is a cross-sectional view showing a portion of the construction of the slot antenna array 300.

FIG. 28C is a plan view showing the structure on the conductive member 120 in the slot antenna array 300.

FIG. 28D is a plan view showing the structure on the conductive member 140 in the slot antenna array 300.

### DETAILED DESCRIPTION

A production method according to an example embodiment of the present disclosure is a method of producing a waveguide-to-coaxial adapter array including a plurality of waveguide-to-coaxial adapters arranged in a two-dimensional array. The waveguide-to-coaxial adapter array includes: an electrically conductive member having a first surface, a second surface opposite to the first surface, a plurality of throughholes extending from the first surface through to the second surface, to which a plurality of coaxial connectors each having a core are to be connected, and a plurality of electrically conductive rods protruding from the second surface and being disposed around the plurality of throughholes. The production method comprises: a step of applying solder paste to an inner surface of each of the plurality of throughholes; a step of inserting the plurality of coaxial connectors respectively in the plurality of throughholes from the first surface side of the electrically conductive member, so that the cores of the plurality of coaxial connectors respectively become located at the inner surfaces of the plurality of throughholes; a step of inserting one or more fixtures having a flat surface in the plurality of throughholes from the second surface side of the electrically conductive member, so that the flat surface of the one or more fixtures is in contact with the cores of the plurality of coaxial connectors and that the cores of the plurality of coaxial connectors are respectively held against the inner surfaces of the plurality of throughholes; a step of connecting the cores of the plurality of coaxial connectors respectively to the inner surfaces of the plurality of throughholes by melting the solder paste applied to the inner surfaces of the plurality of throughholes; and a step of, after performing the step of connecting the cores, disengaging the one or more fixtures from the inner surfaces of the plurality of throughholes, to thereby obtain the waveguide-to-coaxial adapter array.

With the above production method, by using fixtures, the step of connecting the cores of the coaxial connectors respectively to the inner surfaces of the throughholes can be easily performed. Moreover, the state of connection between the core of each coaxial connector and the inner surface of the throughhole can be kept stable. This allows a waveguide-to-coaxial adapter array with more favorable characteristics to be easily produced.

At least one of the one or more fixtures may include a plurality of first portions and a second portion which is continuous with the first portions and which extends in a direction. At the inserting of the one or more fixtures, each of the plurality of first portions may be inserted in a corresponding one of the plurality of throughholes.

In one example embodiment, the step of applying solder paste is performed before the step of inserting the plurality of coaxial connectors respectively in the plurality of throughholes. The step of applying solder paste may be performed after the step of inserting the plurality of coaxial connectors respectively in the plurality of throughholes; however, by performing the step of applying solder paste before the step of inserting the coaxial connectors in the respective throughholes, production can be made even easier.

The above waveguide-to-coaxial adapter array may be used as a constituent element of an antenna array which includes a plurality of horns as antenna elements, for example. Such an antenna array may be produced by connecting a waveguide-to-coaxial adapter array that is produced by the above production method to another electrically conductive member that includes a plurality of horns. Herein, the plurality of horns are disposed so as to be aligned with the positions of the plurality of waveguide-to-coaxial adapters.

A production method according to another example embodiment of the present disclosure is a method of producing a waveguiding device. The waveguiding device includes a first electrically conductive member, a second electrically conductive member, and a plurality of coaxial connectors. The second electrically conductive member has a first surface, a second surface opposite to the first surface, a plurality of throughholes extending from the first surface through to the second surface, a plurality of waveguides protruding from the second surface, and a plurality of electrically conductive rods protruding from the second surface and being disposed around the plurality of throughholes and the plurality of waveguides. The second surface of the second electrically conductive member is opposed to a surface of the first electrically conductive member. The plurality of coaxial connectors are respectively connected to the plurality of throughholes of the second electrically conductive member. Each of the plurality of coaxial connectors includes a core. Ends of the plurality of waveguides are respectively continuous with the inner surfaces of the plurality of throughholes. The production method comprises: a step of applying solder paste to the ends of the plurality of waveguides; a step of inserting the plurality of coaxial connectors respectively in the plurality of throughholes from the first surface side of the second electrically conductive member, so that the cores of the plurality of coaxial connectors respectively become located at the ends of the plurality of waveguides; a step of inserting one or more fixtures having a flat surface in the plurality of throughholes from the second surface side of the second electrically conductive member, so that the flat surface of the one or more fixtures is in contact with the cores of the plurality of coaxial connectors and that the cores of the plurality of coaxial connectors are respectively held against the ends of the plurality of waveguides; a step of connecting the cores of the plurality of coaxial connectors respectively to the ends of the plurality of waveguides by melting the solder paste applied to the ends of the plurality of waveguides; and a step of, after performing the step of connecting, disengaging the one or more fixtures from the ends of the plurality of waveguides, to thereby obtain the second electrically conductive member.

With the above production method, by using fixtures, the step of connecting the cores of the coaxial connectors respectively to the ends of the waveguides can be easily performed. Moreover, the state of connection between the core of each coaxial connector and the end of the waveguide can be kept stable. This allows a waveguiding device with more favorable characteristics to be easily produced.

In one example embodiment, the step of applying solder paste is performed before the step of inserting the plurality of coaxial connectors respectively in the plurality of throughholes. The step of applying solder paste may be performed after the step of inserting the plurality of coaxial connectors respectively in the plurality of throughholes; however, by performing the step of applying solder paste before the step of inserting the coaxial connectors in the respective throughholes, production can be made even easier.

The first electrically conductive member may include a plurality of antenna elements to perform at least one of transmission and reception an electromagnetic wave. For example, the first electrically conductive member may include a plurality of slots each functioning as an antenna element. The front surface of the first electrically conductive member may be shaped so as to define a plurality of horns respectively surrounding the plurality of slots.

Hereinafter, specific exemplary constructions according to example embodiments of the present disclosure will be described. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

### First Example Embodiment: Method of Producing a Waveguide-to-Coaxial Adapter Array

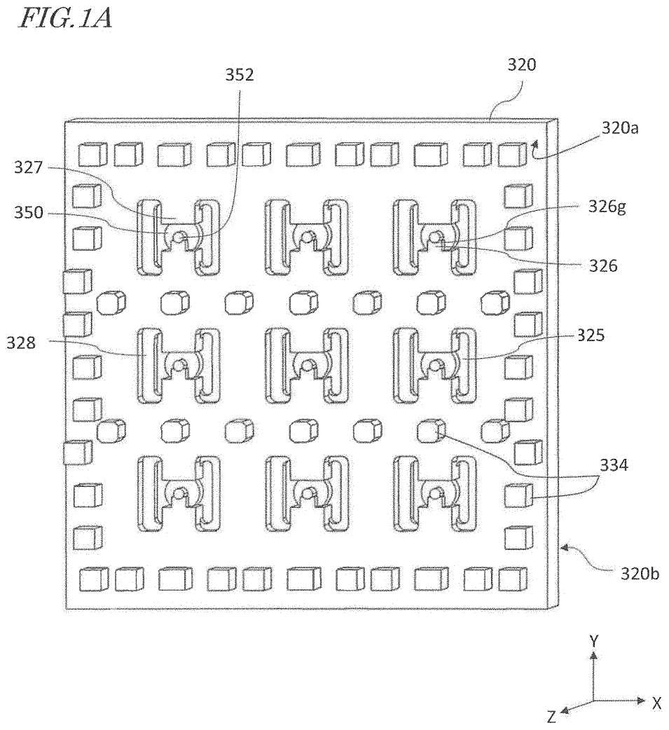

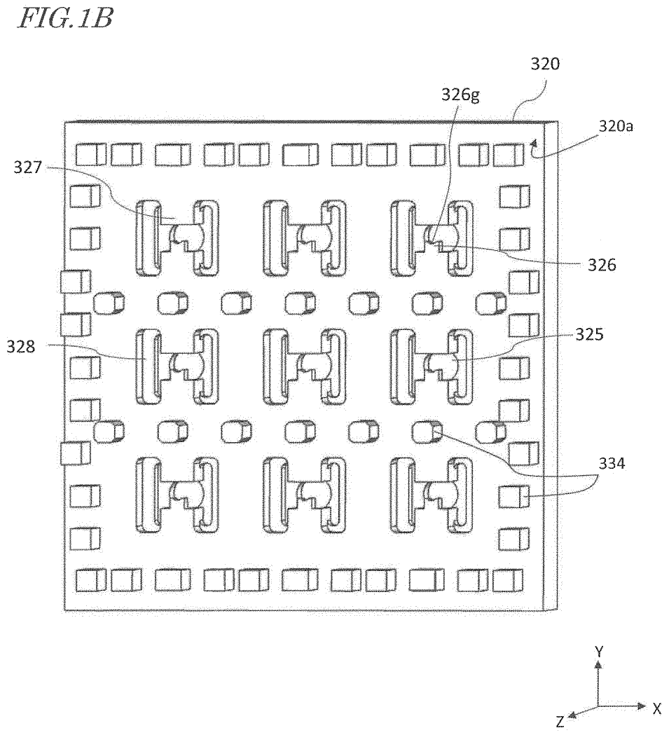

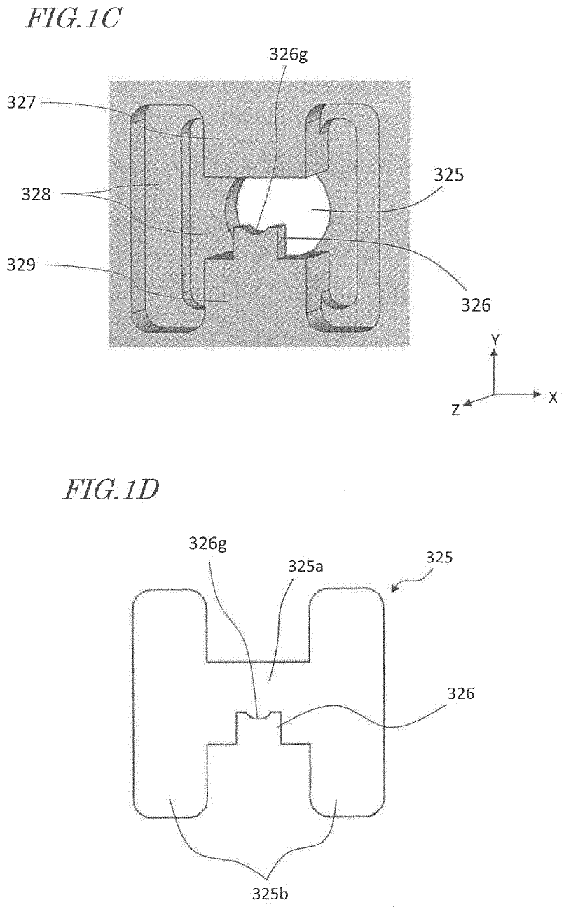

FIG. 1A shows an example of a waveguide-to-coaxial adapter array which is produced by a production method according to a first illustrative example embodiment of the present disclosure. FIG. 1B is a diagram showing a construction resulting after removing coaxial connectors 350 from the waveguide-to-coaxial adapter array shown in FIG. 1A. FIG. 1A and FIG. 1B show XYZ coordinates along X, Y and Z directions which are orthogonal to one another. Hereinafter, the device construction will be described by using this coordinate system. The +Z direction will be referred to as the “front side”, and the −Z direction will be referred to as the “rear side”. The “front side” means the side at which an electromagnetic wave is radiated or the side at which an electromagnetic wave arrives, whereas the “rear side” means the opposite side to the front side. Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size.

As will be described later, the waveguide-to-coaxial adapter array shown in FIG. 1A can be used in combination with a horn array that includes a plurality of horn antenna elements. The waveguide-to-coaxial adapter array includes a plate-like electrically conductive member 320. The conductive member 320 includes: a plurality of throughholes 325; and a plurality of electrically conductive rods 334 that are disposed around the throughholes 325. The plurality of throughholes 325 are arranged in a two-dimensional array along the X direction and along the Y direction.

A core 352 of a coaxial connector 350 is connected to the inner surface of each of the plurality of throughholes 325 of the waveguide-to-coaxial adapter array. Each throughhole 325 functions as a waveguide-to-coaxial adapter which transmits an electromagnetic wave occurring from the core 352 to a hollow waveguide in a horn antenna element (not shown) that is opposed to the throughhole 325.

The conductive member 320 has a flat electrically conductive surface 320a on the front side. The plurality of conductive rods 334 protrude from the conductive surface 320a. The plurality of conductive rods 334 are disposed around the throughholes 325. Although the present example embodiment illustrates that a flat surface surrounds the opening of each throughhole 325, an electrically-conductive wall that surrounds the opening may instead be provided. The conductive member 320 also has a flat conductive surface 320b on the rear side. The coaxial connectors 350 are inserted from the rear-side conductive surface 320b of the conductive member 320. In the present example embodiment, the rear-side conductive surface 320b of the conductive member 320 corresponds to the aforementioned “first surface”, whereas the front-side conductive surface 320a corresponds to the aforementioned “second surface”.

As viewed in the Z direction, the plurality of rods 334 include those rods 334 which are each shifted from the central portion of one of the plurality of throughholes 325 along the Y direction. Some of such rods 334 are located between two adjacent throughholes 325 adjoining along the Y direction. Any rod 334 in between the throughholes 325 is shaped as an octagonal prism. On the other hand, those rods 334 which are around the plurality of throughholes 325 are shaped as quadrangular prisms. Each rod 334 may have any other shape, e.g., a cylindrical shape. Moreover, there may be no rods 334 surrounding the plurality of throughholes 325.

The plurality of rods 334 arranged on the conductive surface 320a constitute a waffle iron structure. As will be described in detail later, the waffle iron structure functions to suppress leakage of electromagnetic waves. By disposing conductive rods 334 of appropriate shapes and dimensions around the throughholes 325 at appropriate intervals, leakage of electromagnetic waves from the waveguide-to-coaxial adapters can be suppressed.

FIG. 1C is a perspective view showing enlarged a throughhole 325. Each throughhole 325 according to the present example embodiment is shaped so that a cross section thereof taken parallel to the XY plane has an increasing geometric area from the rear side toward the front side. The bottom (at the rear side) of each throughhole 325 has a near-circular shape. The front portion of each throughhole 325 is shaped so that the shape of a cross section thereof taken parallel to the XY plane (hereinafter referred to as the “opening shape”) resembles the alphabetical letter “H”. In the present specification, such a shape will be referred to as an “H shape”.

FIG. 1D is a plan view showing the opening shape of a throughhole 325. Each throughhole 325 as illustrated by this example has a lateral portion 325a extending along the X direction and a pair of vertical portions 325b being connected to opposite ends of the lateral portion and extending along the Y direction. The lateral portion 325a of each throughhole 325 connects between the central portions of the pair of vertical portions 325b.

The inner surface of each throughhole 325 according to the present example embodiment includes a pair of protrusions 327 and 329 that protrude inwardly. Between the two, the protrusion 329 has a receiving portion 326 that further protrudes toward the center of the throughhole 325. The receiving portion 326 is located in the center of the lateral portion 325a. An upper face of the receiving portion 326 includes a groove 326g, which has a curved U shape matching the shape of the core 352. This structure allows the core 352 to be easily attached to the receiving portion 326. Without being limited to a U shape, the groove 326g may have any other shape, e.g., a V shape. To the groove 326g of the receiving portion 326, the core 352 of the coaxial connector 350 is connected by soldering.

As shown in FIG. 1C, the conductive member 320 according to the present example embodiment has a step structure, including a bottom face 328 which is located at the vertical portion 325b of each throughhole 325 and which adjoins the center aperture. Owing to this step structure, a cross section taken parallel to the XY plane monotonically enlarges from the bottom toward the opening.

### [Fixture According to First Example Embodiment]

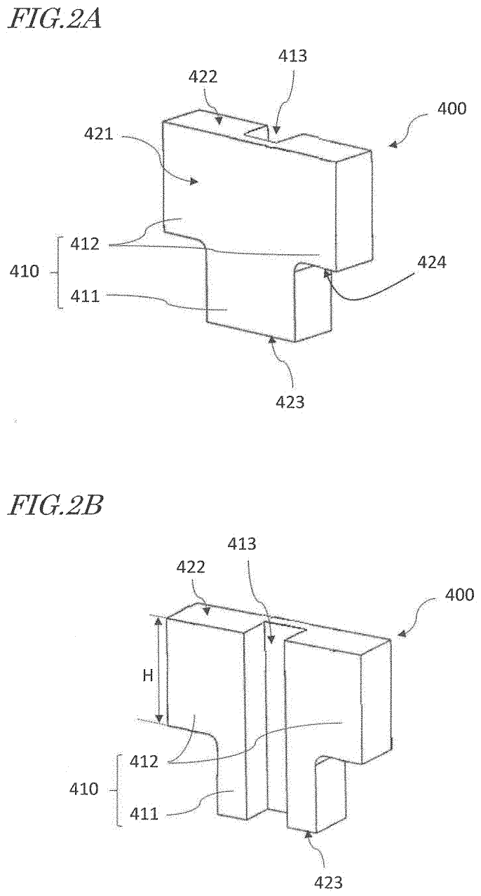

FIG. 2A is a perspective view showing an example of a fixture 400 to be used when producing the aforementioned waveguide-to-coaxial adapter array. FIG. 2B is a perspective view showing the opposite-side structure of the fixture 400 shown in FIG. 2A. The fixture 400 shown in FIG. 2A and FIG. 2B is used, while the core 352 of the coaxial connector 350 is kept in close contact with the receiving portion 326, in order to press the core 352 against the receiving portion 326 as a preparation for soldering.

One fixture 400 is to be used for each throughhole 325 of the conductive member 320 shown in FIG. 1A. The fixture 400 has a plate-like main body 410. The face on one side of the main body 410 shown in FIG. 2A is a flat surface 421, which is in contact with the core 325. The flat surface 421 serves to press the core 352 against the receiving portion 326.

The main body 410 includes a first portion 411 to be inserted in the throughhole 325 of the conductive member 320, and a second portion 412 which is continuous with the first portion 411 and which is broader the first portion 411. A lower end face 423 of the first portion 411 and a lower end face 424 of the second portion 412 are flat.

As shown in FIG. 2B, on the opposite side of the main body 410 of the flat surface 421, the fixture 400 includes a linear-shaped groove 413 that extends from the upper end face 422 to the lower end face 423 of the main body 410. In the example shown, the edge of the groove 413 reaches the upper end face 422 and the lower end face 423 of the main body 410. As a result, in the upper end face 422 and in the lower end face 423 of the main body 410, there is an open portion at which the edge of the groove 413 is located. A protrusion 327 which partly shapes the lateral portion of the H-shaped throughhole 325 is to be placed in the groove 413. Depending on size of the protrusion 327, the width and depth of the groove 413 can be changed as appropriate.

Although the present example embodiment illustrates that the fixture 400 includes the groove 413 extending from the upper end face 422 to the lower end face 423 of the main body 410, the fixture 400 may have other structures. For example, the fixture 400 may include a groove 413 that begins from the lower end face 423 of the main body 410 but does not extend all the way to the upper end face 422. Alternatively, the main body 410 may not have any groove 413 at all. Although lack of the groove 413 in the main body 410 may result in a shifting of the position after attachment of the fixture 400, it may advantageously facilitate the attaching work for the fixture 400.

Regarding the flat surface 421 of the first portion 411 shown in FIG. 2A, a portion thereof that is closer to the lower end face 423 may be parallel to the core 352 when the core 352 is kept in contact with the groove 326g of the receiving portion 326, or sloped so as to become closer to the core 352 from the lower end face 423 toward the upper end face 422. One way of realizing this may be to adopt a tapered shape such that the thickness of the first portion 411 decreases toward the lower end face 423. Adopting such a shape may facilitate the work of mounting the fixture 400 into the throughhole 325.

The height H of the second portion 412, shown in FIG. 2B, may be determined so that the upper end of the second portion 412 is situated higher than the position of the surface 320a of the conductive member 320 when the fixture 400 is attached in the throughhole 325.

The fixture 400 may be composed of a material having sufficient thermal resistance for enduring the environment during reflow soldering. For example, materials such as epoxy resins, fluoroplastics such as PTFE (polytetrafluoroethylene), liquid crystal polymer resins, etc., may be used.

The fixture 400 may be formed into a desired shape as it is cut out from a single piece of material.

### [Method of Producing a Waveguide-to-Coaxial Adapter Array]

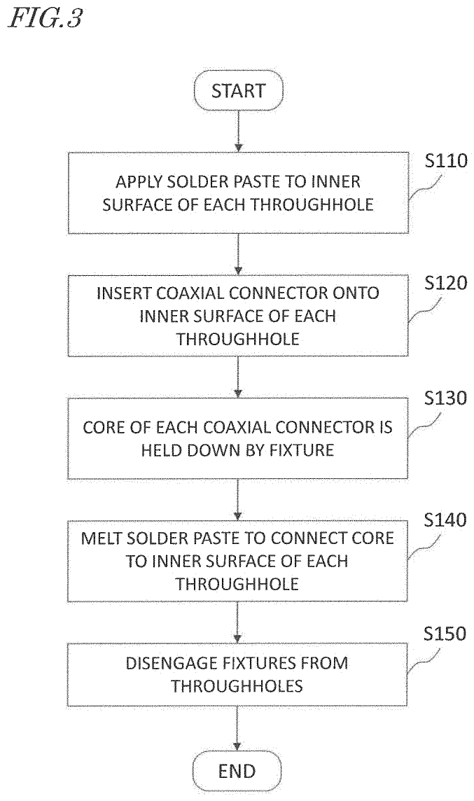

FIG. 3 is flowchart showing a method of producing a waveguide-to-coaxial adapter array according to the present example embodiment. This production method includes an application step (Step S110), an insertion step (Step S120), a hold-down step (Step S130), a connection step (Step S140), and a disengaging step (Step S150). Hereinafter, the respective steps will be described.

(Step S110: Application Step)

Solder paste is applied to the inner surface of each throughhole 325 of the conductive member 320. In the present example embodiment, solder paste is applied to the receiving portion 326, which is located in the central portion of the lateral portion of the respective throughhole 325. Solder paste is to be applied to all receiving portions 326.

(Step S120: Insertion Step)

The plurality of coaxial connectors 350 shown in FIG. 1A are respectively inserted in the plurality of throughholes 325 from the rear side (shown as the back of the plane of figure of FIG. 1A) of the conductive member 320, such that the leading end of each core 352 becomes located at the receiving portion 326. This allows the solder paste to exist between the core 352 and the groove 326g of the receiving portion 326.

(Step S130: Hold-Down Step)

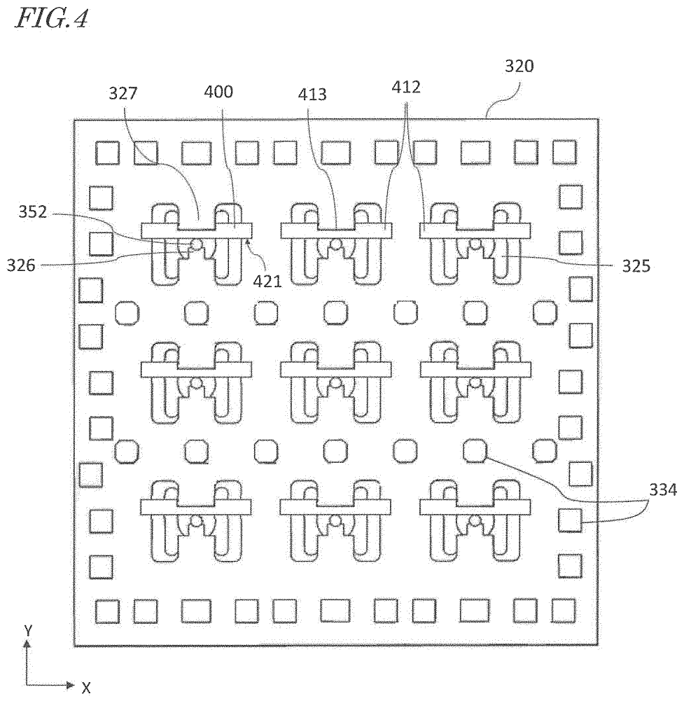

Next, the first portion 411 of the fixture 400 is inserted into the H-shaped throughhole 325 from the front side (shown as the front of the plane of figure of FIG. 1A) of the conductive member 320, and is pressed down until the second portion 412 abuts with the surface 320a of the conductive member 320. At this point, the flat surface 421 of the fixture 400 comes in contact with the core 352, so that the core 352 is held against the receiving portion 326. At this time, under the pressure, the core 352 is aligned in the center of the receiving portion 326. FIG. 4 is a plan view showing the fixtures 400 having been inserted in the throughholes 325. As shown in FIG. 4, the fixtures 400 are inserted in all throughholes 325, and, while the flat surface 421 is kept in contact with the core 352, the core 352 is held against the receiving portion 326.

(Step S140: Connection Step)

Next, the solder paste is melted, thereby connecting the core 352 to the inner surface of the throughhole 325. In the present example embodiment, the conductive member 320 is placed in a reflow oven. Once the conductive member 320 moves to a high-temperature area in the reflow oven, the solder paste on the conductive member 320 melts. Then, the conductive member 320 moves to a cooling area, where the solder paste solidifies to connect the core 352 to the receiving portion 326. During the reflow soldering, the fixture 400 restricts movement of the core 352. This can prevent the core 352 from becoming lifted from the receiving portion 326. After performing the reflow soldering, the conductive member 320 is taken out of the reflow oven.

(Step S150: Disengaging Step)

Once the connection step is completed, the fixtures 400 are disengaged from all throughholes 325, whereby a waveguide-to-coaxial adapter array is obtained. By doing so, the cores 352 are uniformly connected to the receiving portions 326 in all throughholes 325. Note that the fixtures 400 are repeatedly reusable.

Thus, according to the present example embodiment, use of the fixture 400 allows the core 352 of the coaxial connector 350 to be uniformly connected, with ease, to the inner surface of each throughhole 325. As compared to the case where the core 352 is soldered to the inner surface of the throughhole 325 without using the fixture 400, it is easy to ensure that the plurality of waveguide-to-coaxial adapters have matching characteristics. This makes it easier for an antenna array including an waveguide-to-coaxial adapter array to exhibit desired characteristics.

### [Variant of the Fixture According to the First Example Embodiment]

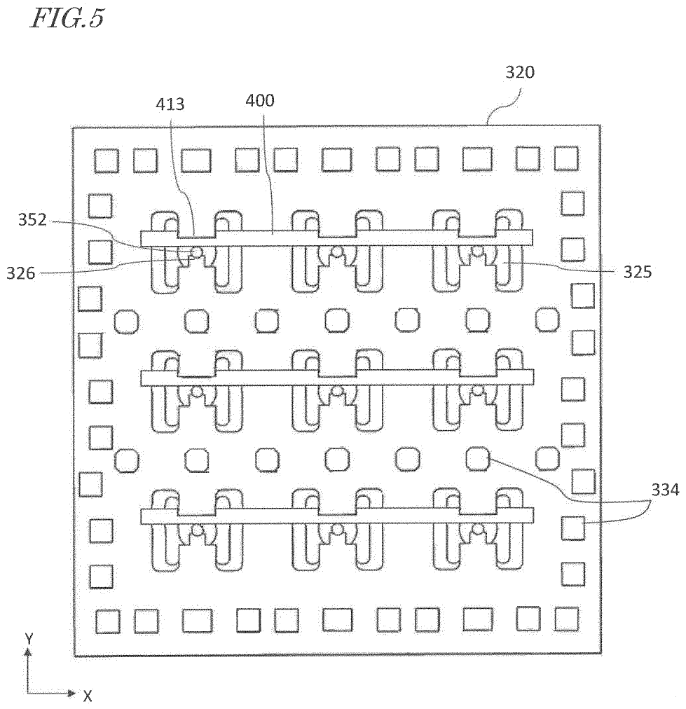

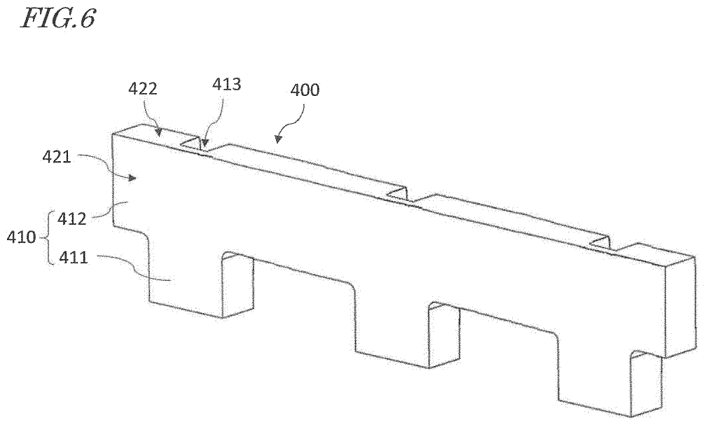

FIG. 5 is a plan view showing fixtures 400 having been inserted in the throughholes 325 of the conductive member 320 according to a variant of the first example embodiment. FIG. 6 is a perspective view showing one fixture 400 used in this variant. Each fixture 400 shown in FIG. 5 and FIG. 6 is constructed so that the second portion 412 of its main body 410 extends along the lateral direction (the X direction). First portions 411 are provided at the respective positions of three adjacent H-shaped throughholes 325 which are arranged side by side. Without being limited to the illustrated length, the length of the second portion 412 of the main body 410 of the fixture 400 along the lateral direction may be changed as appropriate, depending on the number of throughholes 325 to which the cores 352 are connected. In accordance with the fixture 400 of this variant, a single fixture 400 allows the cores 352 to be efficiently connected to the receiving portions 326 at the plurality of throughholes 325. Each fixture 400 may be constructed so that the second portion 412 of its main body 410 extends along the vertical direction. In that case, the second portion 412 of the main body 410 may be constructed so as to avoid the conductive rod 334. In this manner, a single fixture 400 may be inserted into a plurality of throughholes 325.

### [Variant as to the Order of Steps]

In the first example embodiment above, the hold-down step (Step S130) is performed after the application step (Step S110) and the insertion step (Step S120); however, this order is not a limitation. The application step may be performed after the insertion step and the hold-down step. Alternatively, the application step may be performed after the insertion step but before the hold-down step. In other words, the application step may be performed at any appropriate point before the connection step.

### <Method of Producing an Antenna Array>

A waveguide-to-coaxial adapter array produced by the production method according to the first example embodiment and a further conductive member may be connected via a waffle iron structure (to be described in detail later) so as to construct an antenna array. The further conductive member may be a horn array that includes a plurality of horns functioning as antenna elements, for example.

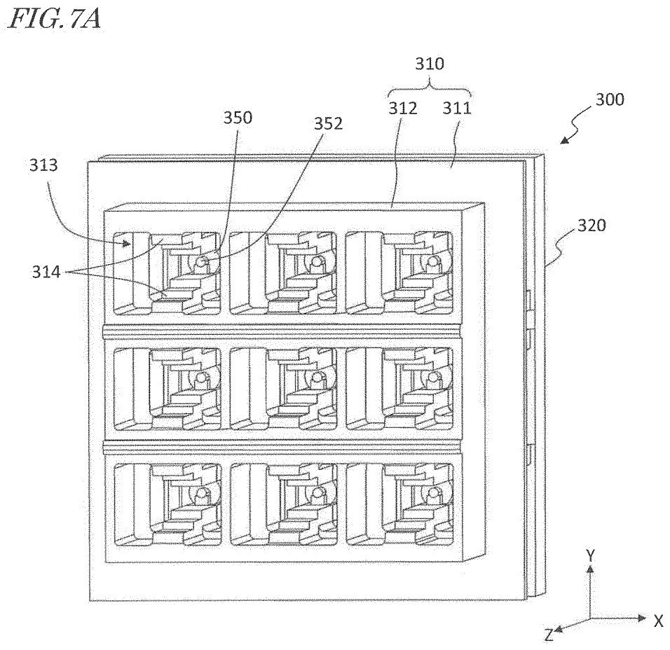

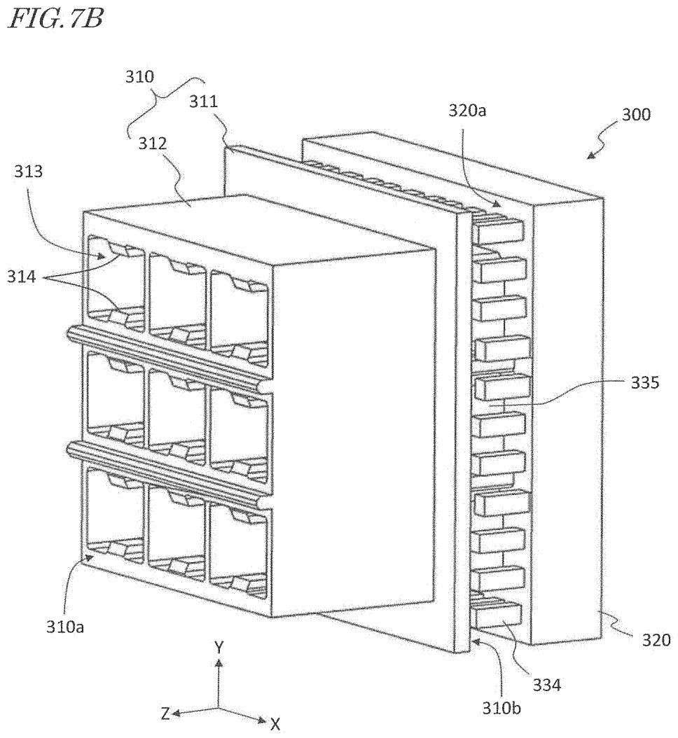

FIG. 7A is a perspective view showing an exemplary antenna array 300. FIG. 7B is a perspective view showing the antenna array as seen from a different angle. The antenna array 300 includes a first conductive member 310 and a second conductive member 320. The first conductive member 310 has an array consisting of a plurality of horns 313 each functioning as an antenna element. The second conductive member 320 has, in the manner illustrated in FIG. 1A, an array consisting of a plurality of waveguide-to-coaxial adapters. The plurality of waveguide-to-coaxial adapters are respectively provided corresponding to the plurality of horns 313. The plurality of horns 313 and the plurality of waveguide-to-coaxial adapters are arranged in a two-dimensional array along a first direction (which in this example is the X direction) and a second direction (which in this example is the Y direction). Although the present example embodiment illustrates that the second direction is orthogonal to the first direction, alternatively the second direction may intersect the first direction at any angle different from 90 degrees.

As antenna elements, the antenna array 300 according to the present example embodiment includes nine horns 313 which are arranged in three rows and three columns. The number of horns 313 may not be nine. For example, 256 horns 313 which are arranged in 16 rows and 16 columns may be used to constitute the antenna array 300. The number and arrangement of horns 313 may be determined in accordance with the application and purpose. The array of horns 313 may not be a simple matrix arrangement.

The first conductive member 310 includes a relatively thin electrically conductive plate 311 and a horn array section 312 that is disposed on the front side of the electrically conductive plate 311. The horn array section 312 includes an outer peripheral wall which is thicker than the electrically conductive plate 311, and, inside the outer peripheral wall, a plurality of hollows respectively defining the plurality of horns 313. The hollow defining each horn 313 is structured so that its internal space enlarges from the rear side toward the front side. On its inner surface, each horn 313 includes a pair of ridges 314 opposing each other. The pair of ridges 314 protrude from the inner surface along a direction (which in this example is the Y direction) intersecting the first direction (which in this example is the X direction), and extends along a plane which is parallel to the Y direction and the Z direction. The gap between the pair of ridges 314 monotonically increases from the rear side toward the front side. The pair of ridges 314 have a staircase-like structure, such that the interval therebetween increases toward the front side. Without being limited to a staircase-like structure, each ridge 314 may be structured so that the interval between the ridges gradually increases. The hollow inside each horn 313 functions as a hollow waveguide. During transmission, the pair of ridges 314 guide a radio-frequency electromagnetic wave occurring from the core 352 of the coaxial connector 350, and allow it to be radiated into the external space.

As shown in FIG. 7B, the first conductive member 310 has a first conductive surface 310a on the front side and a second conductive surface 310b on the rear side. The second conductive member 320 has a third conductive surface 320a on the front side. The third conductive surface 320a is opposed to the second conductive surface 310b. Each of the plurality of hollows defining the horns 313 extends through the first conductive member 310, and opens on the first conductive surface 310a and the second conductive surface 310b. A plurality of conductive rods 334 and a plurality of waveguiding walls 335 are disposed between the second conductive surface 310b and the third conductive surface 320a. Each conductive rod 334 has a root that is connected to the third conductive surface 320a and a leading end opposing the second conductive surface 310b. The conductive rods 334 restrain electromagnetic waves, which are transmitted from the coaxial connectors 350 to the horns 313, from leaking outside. Each conductive rod 334 may be provided on the second conductive surface 310b side. The plurality of waveguiding walls 335 are connected to the second conductive surface 310b.

The first conductive member 310, the second conductive member 320, the plurality of conductive rods 334, and the plurality of waveguiding walls 335 may each be shaped by machining a metal plate, for example. Each member may be shaped by casting, e.g., die casting. Alternatively, each member may be produced by forming a plating layer on the surface of an electrically insulative material, e.g., resin. As the electrically conductive material composing each of the conductive members 310 and 320, the rods 334, and the waveguiding walls 335, a metal such as magnesium may be used, for example. Instead of a plating layer, a layer of electrical conductor may be formed by vapor deposition or the like. In the present example embodiment, the first conductive member 310 and the plurality of waveguiding walls 335 are portions of a single-piece body, while the second conductive member 320 and the plurality of rods 334 are portions of another single-piece body. Each of these single-piece bodies may be fabricated in an integral manner.

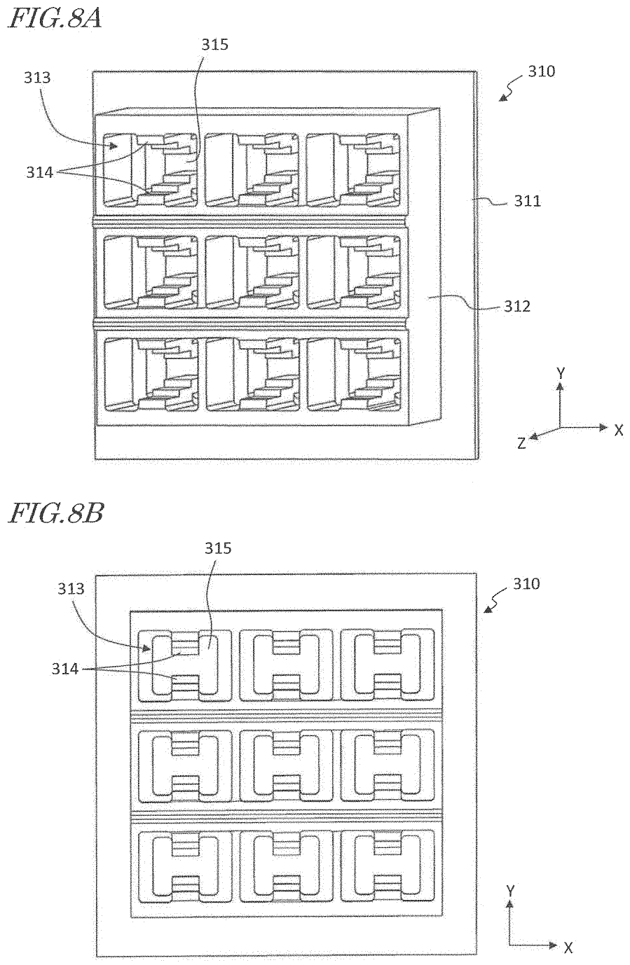

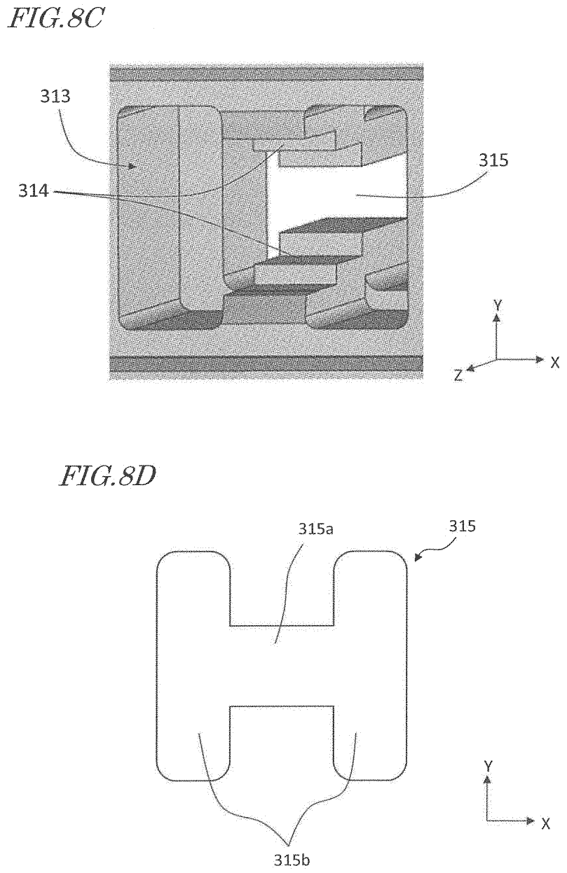

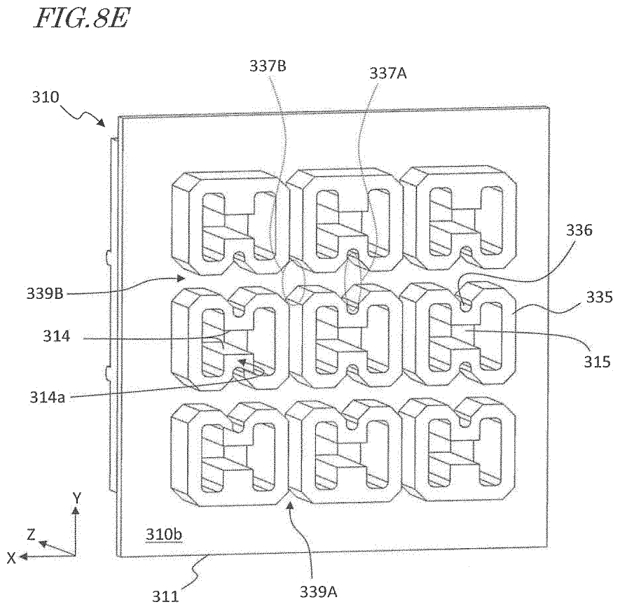

FIG. 8A is a perspective view showing the first conductive member 310. FIG. 8B is a front view showing the first conductive member 310. The first conductive member 310 has a plurality of throughholes 315 which are arranged in a two-dimensional array along the X direction and along the Y direction. Each throughhole 315 opens at the bottom of a hollow defining the horn 313. Each throughhole 315 is continuous with the opening at the front side of the horn 313. The shape of a cross section of each throughhole 315 as taken parallel to the XY plane is an H shape.

FIG. 8C is a perspective view showing enlarged one horn 313. The pair of ridges 314 of each horn 313 in this example have a staircase structure including three steps. The pair of ridges 314 have top faces opposing each other, and between these top faces, an electric field that oscillates mainly along the Y direction is created. During transmission, an electromagnetic wave propagates along the ridge 314 from the rear side to the front side, so as to be radiated into the external space.

FIG. 8D is a diagram showing the opening shape of the throughhole 315 of each horn 313. The throughhole 315 in this example includes a lateral portion 315a extending along the X direction and a pair of vertical portions 315b being connected to opposite ends of the lateral portion 315a and extending along the Y direction. The shape of the throughhole 315 may be any other shape. Regardless of its shape, each throughhole 315 has an opening shape such that at least a central portion thereof extends along the X direction. An electromagnetic wave occurring from the core 352 of the coaxial connector 350 passes through the central portion of the lateral portion 315a of the throughhole 315, so as to be transmitted to the ridge 314.

As shown in FIG. 1A, the second conductive member 320 is a plate-like member having the plurality of throughholes 325. As viewed in a third direction (which in the present example embodiment is the Z direction) that is perpendicular to the first and second directions, the plurality of throughholes 325 are disposed at positions respectively overlapping the plurality of hollows of the first conductive member 310. Each throughhole 325 functions as a waveguide-to-coaxial adapter to transmit an electromagnetic wave occurring from the core 352 of the coaxial connector 350 to the hollow waveguide in the horn 313.

FIG. 8E is a perspective view showing the structure on the rear side of the first conductive member 310. The first conductive member 310 includes the plurality of waveguiding walls 335 on the rear side. The plurality of waveguiding walls 335 respectively surround the plurality of throughholes 315. Similarly to a cross section of each throughhole 315, the inner surface of each waveguiding wall 335 has an H-shaped structure. The inner surface of each waveguiding wall 335 has a shape that defines the pair of ridges 314. The top face of each waveguiding wall 335 is opposed to the conductive surface 320a of the second conductive member 320. The top face of each waveguiding wall 335 includes an end face 314a that is on the side of the pair of ridges 314 being closer to the second conductive member 320. The end face 314a of one of the pair of ridges 314 is opposed to the front face of the receiving portion 326 of the throughhole 325 shown in FIG. 1C. Each waveguiding wall 335 includes a recess 336 on an outer peripheral surface that faces another waveguiding wall 335 that is adjacent along the Y direction. The recesses 336 on the outer peripheral surfaces of two adjacent waveguiding walls 335 adjoining along the Y direction are opposed to each other, such that a gap enlarging portion 337A is created between these waveguiding walls 335. Moreover, a groove 339A extending along the Y direction exists between two adjacent waveguiding walls 335 adjoining along the X direction. Similarly, between two adjacent waveguiding walls 335 adjoining along the X direction, a groove 339B extending along the X direction exists. A gap enlarging portion 337B also exists in the region where these grooves 339A and 339B intersect. The conductive rods 334 on the second conductive member 320 are disposed in the gap enlarging portions 337A and 337B. In the present example embodiment, the conductive rods 334 are disposed at positions adjacent to the recesses 336 of the outer peripheral surfaces of the waveguiding walls 335. Such an arrangement provides improved isolation between radio frequency signals associated with horns 313 adjoining each other along the Y direction, thus allowing the distance between horns 313 to be reduced.

FIG. 9 is a side view of the antenna array 300. The plurality of conductive rods 334 on the second conductive member 320 are located between and around the plurality of waveguiding walls 335 on the first conductive member 310. With such structure, leakage of an electromagnetic wave propagating between each coaxial cable and each horn 313 is effectively suppressed.

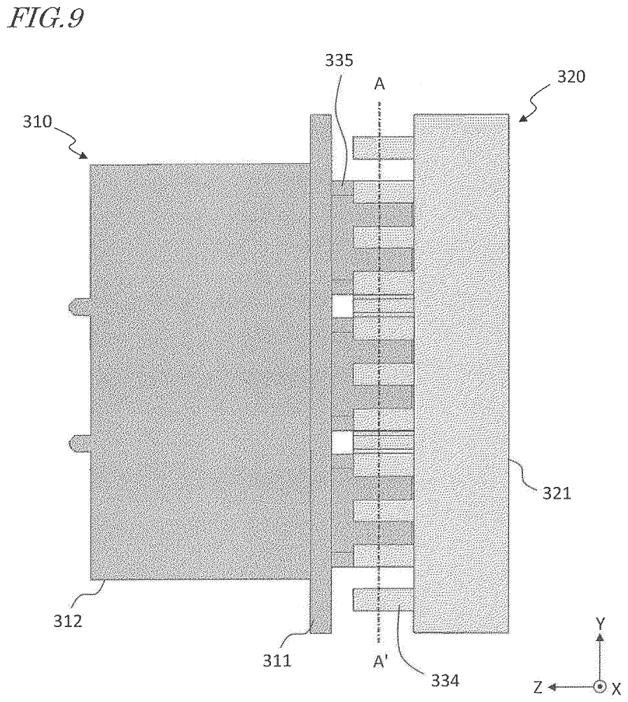

FIG. 10 is a cross-sectional view of an antenna array 300 as taken along line A-A′ in FIG. 9. FIG. 10 shows both cross sections of the waveguiding walls 335 and cross sections of the conductive rods 334. As shown in the figure, those conductive rods 334 which are located between the waveguiding walls 335 are accommodated in the gap enlarging portions between the waveguiding wall 335.

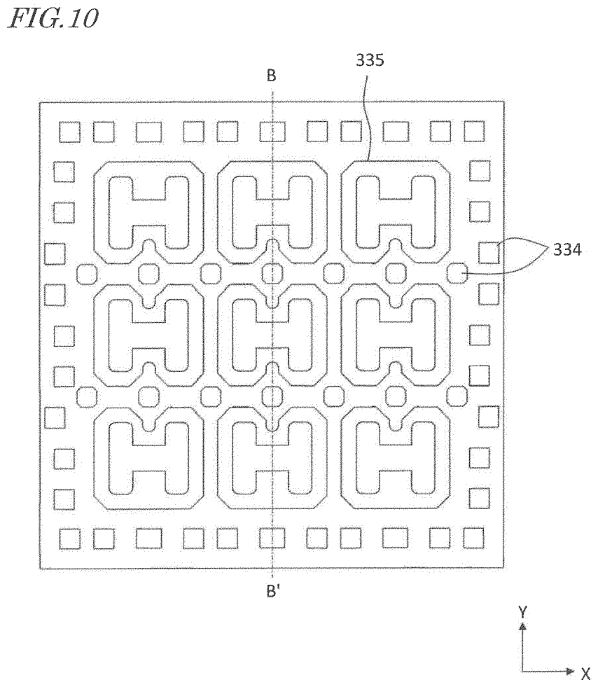

FIG. 11 is a cross-sectional view of an antenna array 300 as taken along line B-B′ in FIG. 10. FIG. 11 shows cross sections of the inner wall surfaces of the horns 313, cross sections of the waveguiding walls 335, and cross sections of the conductive rods 334 and the coaxial connectors 350 that contain their axial directions. An end of the core 352 of each coaxial connector 350 reaches near the conductive surface 320a of the second conductive member 320, where it is connected to the inner surface of the throughhole 325. With such structure, after the second conductive member 320 functioning as a waveguide-to-coaxial adapter array is produced, sureness of connections between the cores 352 and the conductive member 320 can be easily confirmed, each individually.

A slight gap exists between each waveguiding wall 335 and the conductive surface 320a of the second conductive member 320. A gap dl between the waveguiding wall 335 and the conductive surface 320a is smaller than a gap d2 between the leading end of each conductive rod 334 and the rear-side conductive surface 310b of the first conductive member 310. Inside each waveguiding wall 335 is formed a throughhole 315 which is continuous from a throughhole 325 in the second conductive member 320 to a horn 313 in the first conductive member 310. Note that dl may be zero; in other words, the waveguiding walls 335 may be in contact with the conductive surface 320a of the second conductive member 320.

In the present example embodiment, on the rear side of the first conductive member 310, the plurality of waveguiding walls 335 respectively surrounding the plurality of throughholes 315 are provided. Moreover, on the front side of the second conductive member 320, the plurality of conductive rods 334 surrounding the plurality of waveguiding walls 335 are provided. With such structure, isolation between signals associated with adjacent waveguide-to-coaxial adapters is improved, thus allowing the plurality of waveguide-to-coaxial adapters, and also the plurality of horns, to be closely located together.

Thus, the antenna array 300 includes: the first conductive member 310 (also referred to as a “horn array”) constituting a two-dimensional array of horn antenna elements; and the second conductive member 320 (also referred to as a “converter array”) constituting a two-dimensional array of waveguide-to-coaxial adapters. The converter array and the horn array may be fixed to each other by using parts such as screws, for example. With such structure, an antenna array that is easy to produce and excels in maintainability can be realized. For example, if a problem arises after the antenna array begins to be used, the converter array and the horn array can be separated, whereby the state of connection between the core 352 of each coaxial connector 350 and each throughhole 325 of the converter array can be easily confirmed. Moreover, since the converter array and the horn array are connected via a waffle-iron structure, leakage of electromagnetic waves propagating between the two can be suppressed.

A communications technique called Massive MIMO has been known in the recent years. Massive MIMO is a technique which in some cases employs 100 or more antenna elements to realize a drastic increase in channel capacity. According to Massive MIMO, a multitude of users are able to simultaneously connect by using the same frequency band. Massive MIMO is useful in utilizing a relatively high frequency such as the 20 GHz band, and may be utilized in communications under the 5th-generation wireless systems (5G) or the like. A transmission line device according to an example embodiment of the present disclosure can be used not only in radar devices, but also in communications utilizing Massive MIMO. This antenna array can be used not only in communication systems, but also in radar systems.

FIG. 12 is a schematic diagram showing an exemplary structure on the rear side of the second conductive member 320. A plurality of connectors 350 are located on the rear side of the second conductive member 320. The interval at which the connectors 350 are disposed is equal to the interval at which the horn antenna elements are disposed. A coaxial cable is to be connected to each connector 350.

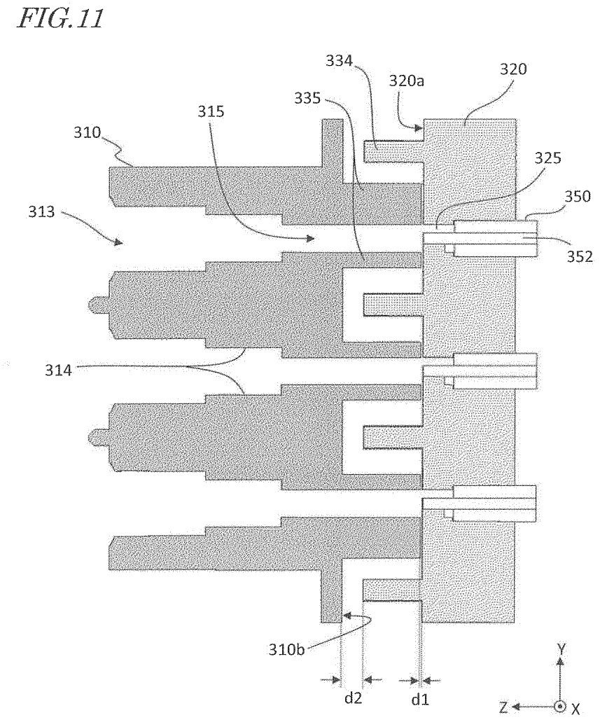

FIG. 13 is a diagram showing schematically showing an exemplary construction of a communication system that includes the antenna array 300 and the communication device 600. This system may be a massive MIMO system, for example. The communication device 600 includes a plurality of connectors 360. The antenna array 300 and the communication device 600 are connected via a plurality of coaxial cables 340. The communication device 600 accommodates a plurality of transmitters inside, and is able to transmit signals of independent phases to the respective coaxial cables 340. The number of coaxial cables 340 is equal to the number of horn antenna elements in the antenna array 300. The interval between connectors 350 in the antenna array 300 is smaller than the interval between connectors 360 in the communication device 600.

### Second Example Embodiment: Method of Producing a Waveguiding Device

Next, an example embodiment of a method of producing a waveguiding device will be described.

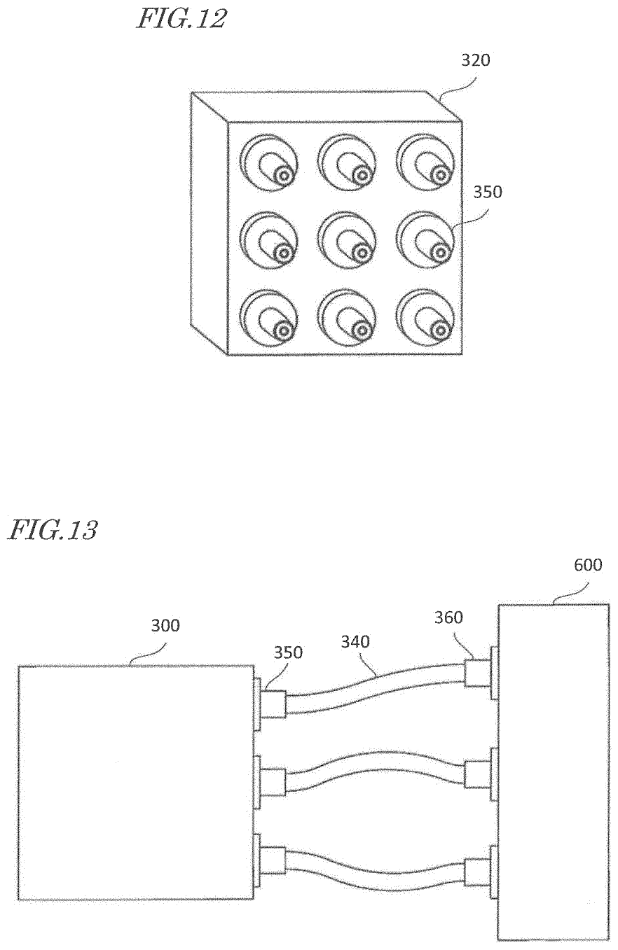

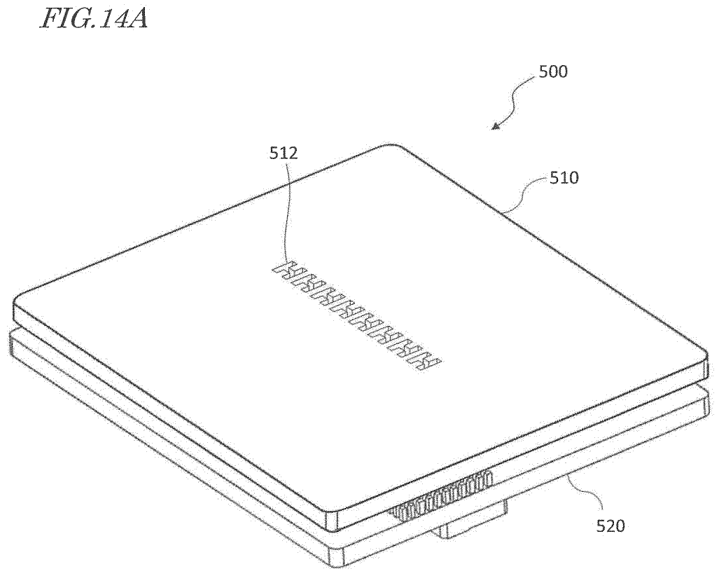

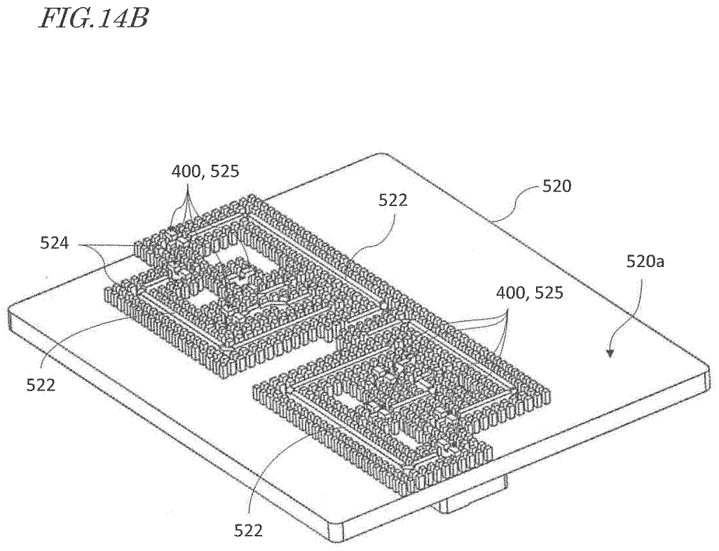

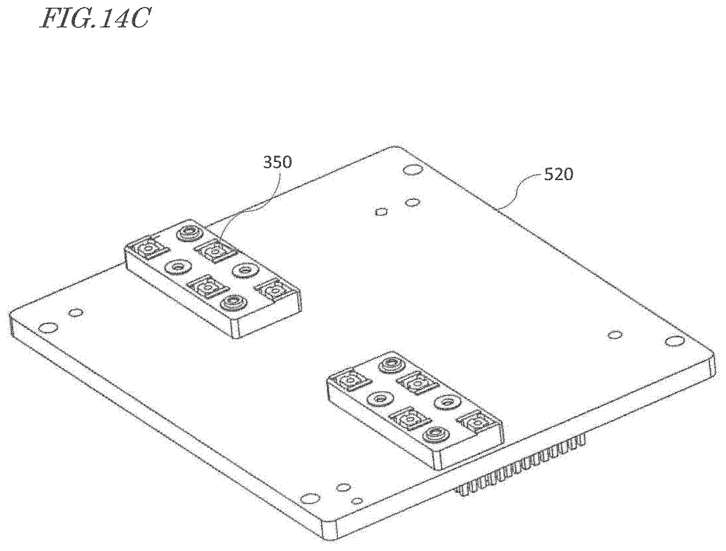

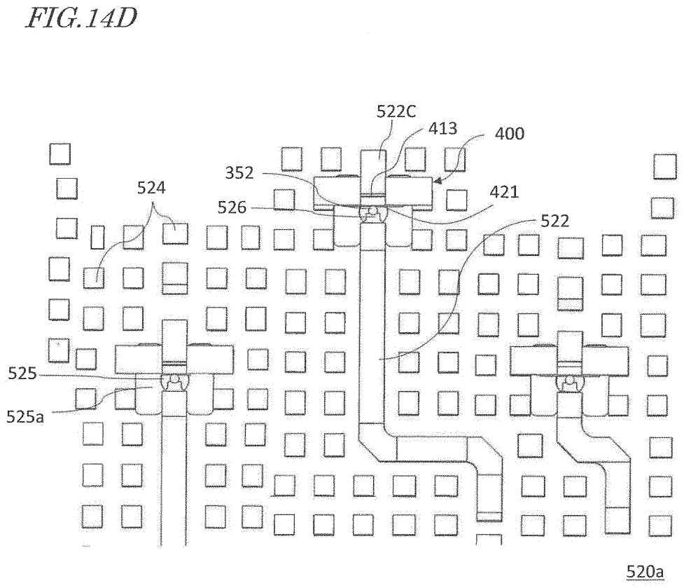

FIG. 14A is a perspective view showing an exemplary construction of a waveguiding device 500. The waveguiding device 500 includes a plate-like first conductive member 510 and a plate-like second conductive member 520 opposing the first conductive member 510. Each of the first conductive member 510 and the second conductive member 520 has a conductive surface. The conductive surface of the first conductive member 510 is opposed to the conductive surface of the second conductive member 520 via a gap. The first conductive member 510 has a plurality of slots 512, i.e., throughholes, each functioning as an antenna element. Although the present example embodiment illustrates that the slots 512 have an H shape, they may have other shapes.

FIG. 14B is a perspective view showing structure remaining after removing the first conductive member 510 from the waveguiding device 500 shown in FIG. 14A. The second conductive member 520 includes a plurality of ridge-shaped waveguides 522 (which may hereinafter be referred to as “ridges 522”), a plurality of throughholes 525, and a plurality of conductive rods 524 which are disposed around the plurality of throughholes 525. In FIG. 14B, a plurality of fixtures 400 to be used during production of the waveguiding device 500 are also shown. The fixtures 400 are to be disengage after production.

FIG. 14C is a perspective view showing the opposite-side structure of the second conductive member 520 shown in FIG. 14B. The waveguiding device 500 includes a plurality of coaxial connectors 350 to be connected to the second conductive member 520. Each coaxial connector 350 includes a core.

The second conductive member 520 shown in FIG. 14B and FIG. 14C functions as a feeding layer to feed power to the plurality of slots 512 in the first conductive member 510. The second conductive member 520 has a conductive surface 520a opposing the conductive surface of the first conductive member 510. The plurality of ridges 522 and the plurality of conductive rods 524 are disposed on the conductive surface 520a of the second conductive member 520. Via a gap, the first conductive member 510 is layered on the second conductive member 520. A plurality of waveguides are defined between the conductive surface of the first conductive member 510 and the upper face (which is referred to as the “waveguide face” in the present specification) of the plurality of ridges 522. These waveguides are connected to the plurality of slots 512 of the first conductive member 510. With such structure, the waveguiding device 500 is able to function as an antenna array. Thus, one or more antenna elements may be realized by one or more slots that are provided in the first conductive member 510. Such slots may be provided at positions opposing the at least one wave-guide face(s) of the plurality of ridges 522.

FIG. 14D is a diagram showing enlarged the structure on the conductive surface 520a of the second conductive member 520. The second conductive member 520 includes the plurality of ridges 522, a plurality of conductive rods 524 surrounding each ridge 522, a plurality of H-shaped recesses 525a located at ends of the plurality of ridges 522, and a throughhole 525 located in the center of each recess 525a. The end of each ridge 522 includes a receiving portion 526 to which a core 352 is to be soldered. The receiving portion 526 has a U-shaped groove. The groove may have any other shape, such as a V shape. The ends of the plurality of waveguides 522 are respectively continuous with the inner surfaces of the plurality of throughholes 525. As viewed from a direction perpendicular to the conductive surface 520a of the second conductive member 520, the end of each ridge 522 overlaps the throughhole 525.

### [Fixture According to Second Example Embodiment]

FIG. 15A is a perspective view showing a fixture 400 to be used during production of the aforementioned waveguiding device 500. FIG. 15B is a diagram showing the opposite-side structure of the fixture 400 in FIG. 15A. As shown in FIG. 15A, the fixture 400 includes a plate-like main body 410. As in the first example embodiment, the face on one side of the main body 410 is a flat surface 421. The main body 410 includes: a first portion 411 to be inserted in a throughhole 525 of the second conductive member 520; and a second portion 412 which is continuous with the first portion 411 and is broader than the first portion 411.

On the opposite side of the main body 410 shown in FIG. 15B, a linear-shaped groove 413 is provided which extends from an upper end to a lower end of the main body 410. Unlike the fixture 400 according to the first example embodiment, the fixture 400 according to the second example embodiment is dented at the central portion of the upper end of the main body 410, thus creating a large opening. The second portion 412 of the fixture 400 according to the second example embodiment is shorter than the second portion of the fixture 400 according to the first example embodiment.

### [Method of Producing a Waveguiding Device]

Similarly to the production method illustrated in FIG. 3, a method of producing a waveguiding device according to the present example embodiment includes an application step, an insertion step, a hold-down step, a connection step, and a disengaging step. Hereinafter, the respective steps will be described.

(Application Step)

Solder paste is applied to the receiving portions 526 at the leading ends of the ridges 522 shown in FIG. 14D. Solder paste is to be applied to all receiving portions 526.

(Insertion Step)

The plurality of coaxial connectors 350 shown in FIG. 14C are respectively inserted in the plurality of throughholes 525 from the rear side of the second conductive member 520, such that the leading end of each core 352 shown in FIG. 14D becomes located in the groove of the receiving portion 526. As a result of this, the solder paste exists between the core 352 and the groove of the receiving portion 526.

(Hold-Down Step)

Next, as shown in FIG. 16, the first portion 411 of the fixture 400 is inserted into the recess 525a of the throughhole 525 from the front side of the second conductive member 520, and is pressed down until the second portion 412 abuts with the conductive rod(s) 524 protruding from the surface 520a of the second conductive member 520. At this time, the flat surface 421 of the fixture 400 comes in contact with the core 352, such that the core 352 is held against the receiving portion 526. At this time, under the pressure, the core 352 is aligned in the groove in the center of the receiving portion 526. A choke ridge 522C, which is a part of the ridge 522, fits in the groove 413 of the fixture 400. Note that the choke ridge 522C is a portion separated from the other portion of the ridge 522, and, together with one or more conductive rods 524 which are adjacent along the direction that the ridge 522 extends, constitutes a choke structure. The choke structure suppresses leakage of an electromagnetic wave from the end of the ridge 522. The fixtures 400 are inserted in all H-shaped recesses 525a, and the flat surface 421 is placed in contact with the cores 352, and held against the receiving portions 526.

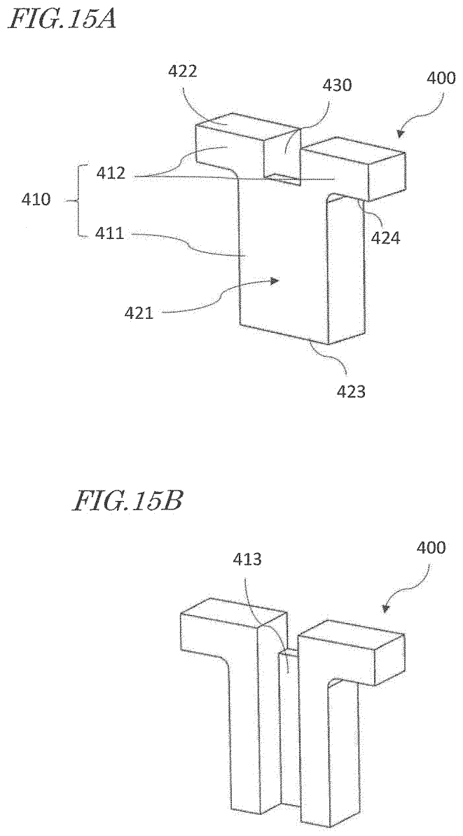

FIG. 17 is a cross-sectional view of a coaxial connector 350, a fixture 400, a throughhole 525, and the end of a ridge 522. As shown in FIG. 17, when inserted in the H-shaped recess 525a, the height of the upper face of the second portion 412 of the fixture 400 is higher than the height of the waveguide face of the ridge 522.

(Connection Step)

A connection step similar to that in the first example embodiment is performed.

(Disengaging Step)

Once the connection step is completed, the fixtures 400 are disengaged from all H-shaped recesses 525a, whereby a second conductive member 520 is obtained. By doing so, the cores 352 are uniformly connected to the receiving portions 526 in all H-shaped recesses 525a. Note that the fixtures 400 are repeatedly reusable, as in the first example embodiment.

After the second conductive member 520 is produced by the above method, the first conductive member 510 and the second conductive member 520 are connected together so as to face each other. Connection may be achieved by using parts such as screws not shown, for example.

Thus, according to the present example embodiment, use of the fixture 400 allows the core 352 of the coaxial connector 350 to be uniformly connected, with ease, to the end of the ridge 522. As compared to the case where the core 352 is soldered to the end of the ridge 522 without using the fixture 400, it is easy to ensure that the plurality of plurality of antenna elements have matching characteristics. This makes it easier for an antenna array to exhibit desired characteristics.

### [Variant of the Fixture According to the Second Example Embodiment]

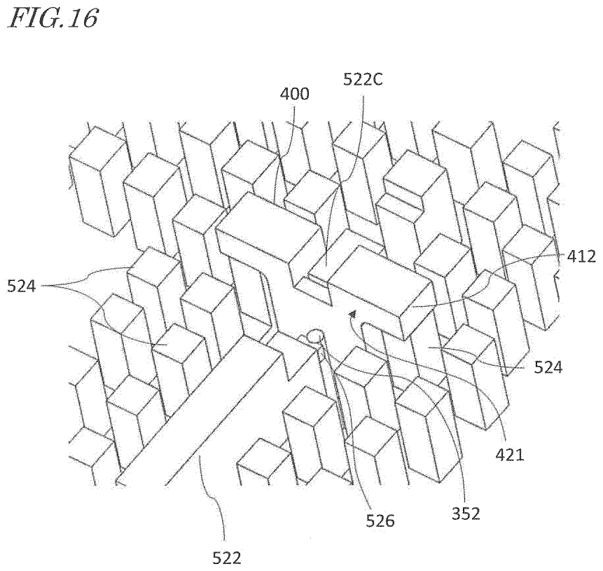

FIG. 18 is a diagram showing a variant of the fixture 400 according to the second example embodiment. As shown in FIG. 18, the fixture 400 includes a plate-like main body 410. The main body 410 includes: a first portion 411 to be inserted in a throughhole 525 of the second conductive member 520; and second portions 412 which are continuous with the first portion 411. Each second portion 412 is broader in width than the first portion 411, and is stepped at the outer end so as to be thinner than the first portion 411. When a connection step is performed by using the fixture 400 according to this variant, the flat surface of the second portion 412 will come in contact with the side faces of the conductive rods 524.

### [Variant as to the Order of Steps]

In the second example embodiment, too, the hold-down step is performed after the application step and the insertion step, as in the first example embodiment; however, this order is not a limitation. The application step may be performed after the insertion step and the hold-down step. Alternatively, the application step may be performed after the insertion step but before the hold-down step. In other words, the application step may be performed at any appropriate point before the connection step.

Note that the structures according to the above-described example embodiments and their variants are illustrative only, and admit of modifications. For example, the numbers, shapes, positions, and dimensions of throughholes, conductive rods, and waveguides of each conductive member may be altered depending on the application and the required characteristics. The structure of the fixtures 400 to be used in producing the waveguide-to-coaxial adapter array, the waveguiding device, or the antenna device similarly admits of various modifications.

Although each of the above example embodiments illustrates a method for respectively connecting the cores of a plurality of coaxial connectors to a plurality of throughholes, a similar method may also be employed in order to connect the core of a single coaxial connector to a single throughhole.

### [Exemplary Construction of WRG]

Next, an exemplary construction of a waffle-iron ridge waveguide (WRG) that is included in the waveguide-to-coaxial adapter array, the waveguiding device, or the antenna device will be described in more detail. A WRG is a ridge waveguide that may be provided in a waffle iron structure functioning as an artificial magnetic conductor. Such a ridge waveguide is able to realize an antenna feeding network with low losses in the microwave or the millimeter wave band. Moreover, use of such a ridge waveguide allows antenna elements to be disposed with a high density. Hereinafter, an exemplary fundamental construction and operation of such a waveguide structure will be described.

An artificial magnetic conductor is a structure which artificially realizes the properties of a perfect magnetic conductor (PMC), which does not exist in nature. One property of a perfect magnetic conductor is that “a magnetic field on its surface has zero tangential component”. This property is the opposite of the property of a perfect electric conductor (PEC), i.e., “an electric field on its surface has zero tangential component”. Although no perfect magnetic conductor exists in nature, it can be embodied by an artificial structure, e.g., an array of a plurality of electrically conductive rods. An artificial magnetic conductor functions as a perfect magnetic conductor in a specific frequency band which is defined by its structure. An artificial magnetic conductor restrains or prevents an electromagnetic wave of any frequency that is contained in the specific frequency band (propagation-restricted band) from propagating along the surface of the artificial magnetic conductor. For this reason, the surface of an artificial magnetic conductor may be referred to as a high impedance surface.

For example, a plurality of electrically conductive rods that are arranged along row and column directions may constitute an artificial magnetic conductor. Such rods may be referred to posts or pins. Each of these waveguiding devices, as a whole, includes a pair of opposing electrically conductive plates. One of the electrically conductive plates has a ridge that protrudes toward the other electrically conductive plate, and an artificial magnetic conductor that are located on both sides of the ridge. Via a gap, an upper face (which is an electrically-conductive face) of the ridge is opposed to the electrically conductive surface of the other electrically conductive plate. An electromagnetic wave (signal wave) of a wavelength which is contained in the propagation stop band of the artificial magnetic conductor propagates along the ridge, in the space (gap) between this conductive surface and the upper face of the ridge.

FIG. 19 is a perspective view showing a non-limiting example of a fundamental construction of such a waveguiding device. The waveguiding device 100 shown in the figure includes a plate shape (plate-like) electrically conductive members 110 and 120, which are in opposing and parallel positions to each other. A plurality of electrically conductive rods 124 are arrayed on the conductive member 120.

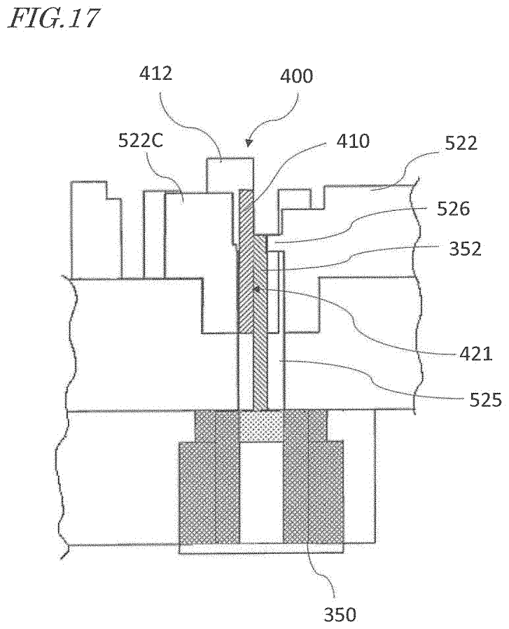

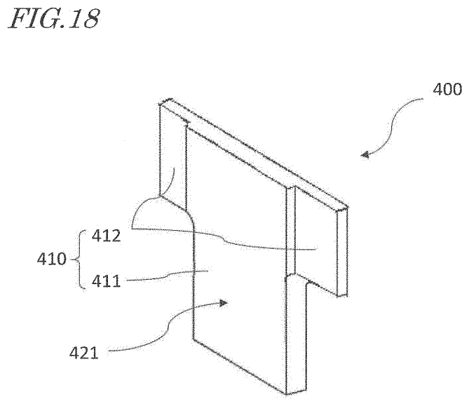

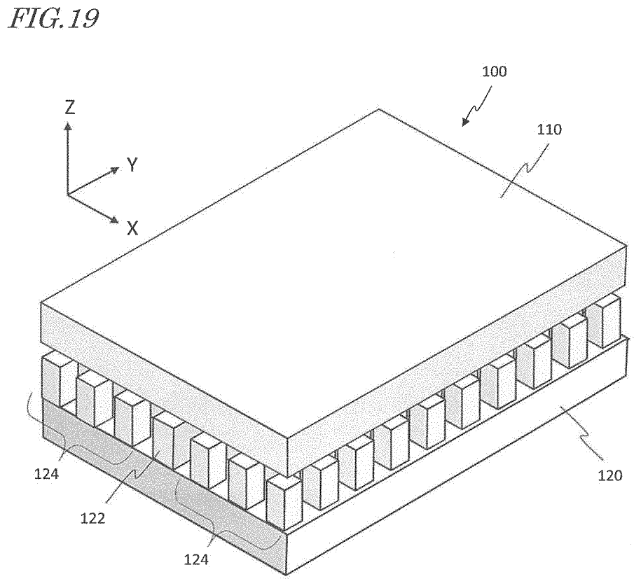

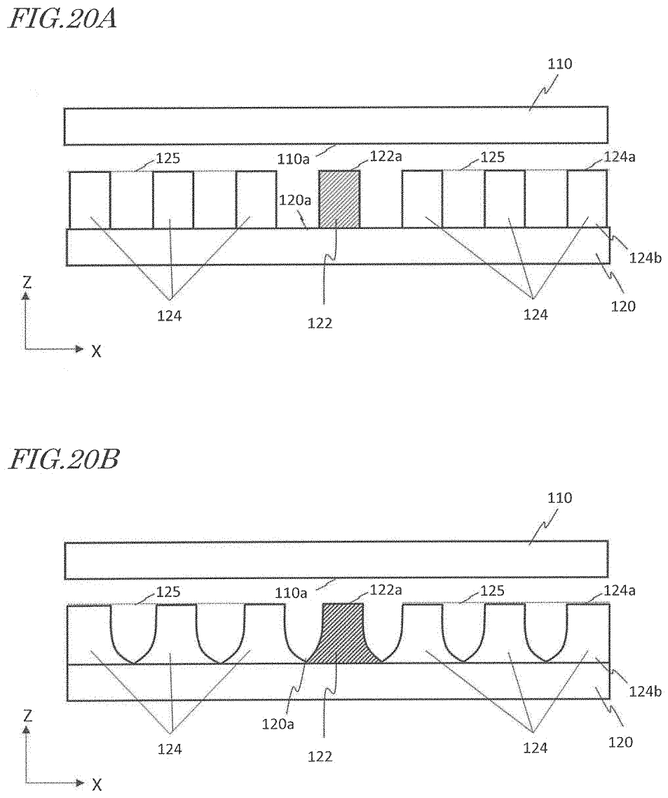

FIG. 20A is a diagram schematically showing a cross-sectional construction of the waveguiding device 100 as taken parallel to the XZ plane. As shown in FIG. 20A, the conductive member 110 has an electrically conductive surface 110a on the side facing the conductive member 120. The conductive surface 110a has a two-dimensional expanse along a plane which is orthogonal to the axial direction (i.e., the Z direction) of the conductive rods 124 (i.e., a plane which is parallel to the XY plane). Although the conductive surface 110a is shown to be a smooth plane in this example, the conductive surface 110a does not need to be a plane, as will be described later.

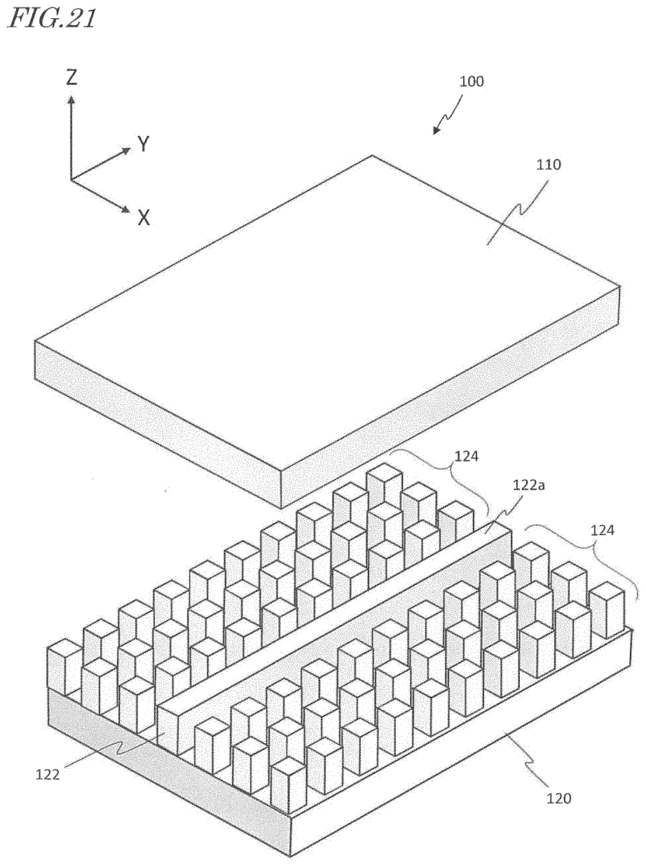

FIG. 21 is a perspective view schematically showing the waveguiding device 100, illustrated so that the spacing between the conductive member 110 and the conductive member 120 is exaggerated for ease of understanding. In an actual waveguiding device 100, as shown in FIG. 19 and FIG. 20A, the spacing between the conductive member 110 and the conductive member 120 is narrow, with the conductive member 110 covering over all of the conductive rods 124 on the conductive member 120.

FIG. 19 to FIG. 21 only show portions of the waveguiding device 100. The conductive members 110 and 120, the waveguide 122, and the plurality of conductive rods 124 actually extend to outside of the portions illustrated in the figures. At an end of the waveguide 122, a choke structure for preventing electromagnetic waves from leaking into the external space is provided. As described earlier, the choke structure may include a row of conductive rods that are adjacent to the end of the waveguide 122, for example.

See FIG. 20A again. The plurality of conductive rods 124 arrayed on the conductive member 120 each have a leading end 124a opposing the conductive surface 110a. In the example shown in the figure, the leading ends 124a of the plurality of conductive rods 124 are on the same plane or on substantially the same plane. This plane defines the surface 125 of an artificial magnetic conductor. Each conductive rod 124 does not need to be entirely electrically conductive, so long as it includes an electrically conductive layer which extends at least along the upper face and the side faces of the rod-like structure. This electrically conductive layer may be located on the surface layer of the rod-like structure; alternatively, the surface layer may be composed of insulation coating or a resin layer, with no electrically conductive layer being present on the surface of the rod-like structure. Moreover, each conductive member 120 does not need to be entirely electrically conductive, so long as it can support the plurality of conductive rods 124 to constitute an artificial magnetic conductor. Of the surfaces of the conductive member 120, a face carrying the plurality of conductive rods 124 may be electrically conductive, such that the electrical conductor electrically interconnects the surfaces of adjacent ones of the plurality of conductive rods 124. The electrically conductive layer of the conductive member 120 may be covered with insulation coating or a resin layer. In other words, the entire combination of the conductive member 120 and the plurality of conductive rods 124 may at least include an electrically conductive layer with rises and falls opposing the conductive surface 110a of the conductive member 110.

On the conductive member 120, a ridge-like waveguide 122 is provided among the plurality of conductive rods 124. More specifically, stretches of an artificial magnetic conductor are present on both sides of the waveguide 122, such that the waveguide 122 is sandwiched between the stretches of artificial magnetic conductor on both sides. As can be seen from FIG. 21, the waveguide 122 in this example is supported on the conductive member 120, and extends linearly along the Y direction. In the example shown in the figure, the waveguide 122 has the same height and width as those of the conductive rods 124. As will be described later, however, the height and width of the waveguide 122 may have respectively different values from those of the conductive rod 124. Unlike the conductive rods 124, the waveguide 122 extends along a direction (which in this example is the Y direction) in which to guide electromagnetic waves along the conductive surface 110a. Similarly, the waveguide 122 does not need to be entirely electrically conductive, but may at least include an electrically conductive waveguide face 122a opposing the conductive surface 110a of the conductive member 110. The conductive member 120, the plurality of conductive rods 124, and the waveguide 122 may be portions of a continuous single-piece body. Furthermore, the conductive member 110 may also be a portion of such a single-piece body.

On both sides of the waveguide 122, the space between the surface 125 of each stretch of artificial magnetic conductor and the conductive surface 110a of the conductive member 110 does not allow an electromagnetic wave of any frequency that is within a specific frequency band to propagate. This frequency band is called a “prohibited band”. The artificial magnetic conductor is designed so that the frequency of an electromagnetic wave (signal wave) to propagate in the waveguiding device 100 (which may hereinafter be referred to as the “operating frequency”) is contained in the prohibited band. The prohibited band may be adjusted based on the following: the height of the conductive rods 124, i.e., the depth of each groove formed between adjacent conductive rods 124; the diameter of each conductive rod 124; the interval between conductive rods 124; and the size of the gap between the leading end 124a and the conductive surface 110a of each conductive rod 124.

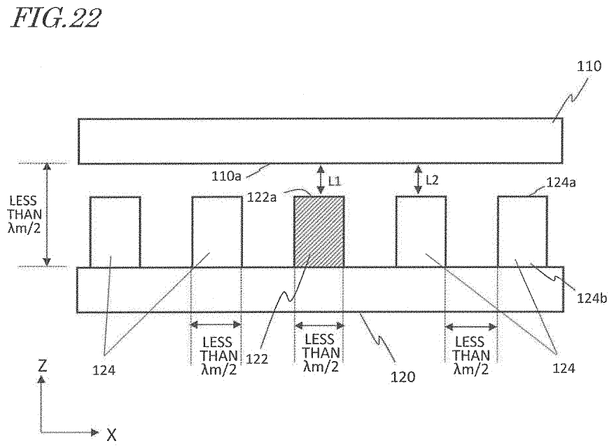

Next, with reference to FIG. 22, the dimensions, shape, positioning, and the like of each member will be described.

FIG. 22 is a diagram showing an exemplary range of dimension of each member in the structure shown in FIG. 20A. The waveguiding device is used for at least one of transmission and reception of electromagnetic waves of a predetermined band (referred to as the “operating frequency band”). In the present specification, λo denotes a representative value of wavelengths in free space (e.g., a central wavelength corresponding to a center frequency in the operating frequency band) of an electromagnetic wave (signal wave) propagating in a waveguide extending between the conductive surface 110a of the conductive member 110 and the waveguide face 122a of the waveguide 122. Moreover, λm denotes a wavelength, in free space, of an electromagnetic wave of the highest frequency in the operating frequency band. The end of each conductive rod 124 that is in contact with the conductive member 120 is referred to as the “root”. As shown in FIG. 22, each conductive rod 124 has the leading end 124a and the root 124b. Examples of dimensions, shapes, positioning, and the like of the respective members are as follows.

(1) width of the conductive rod

The width (i.e., the size along the X direction and the Y direction) of the conductive rod 124 may be set to less than λ m/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

(2) distance from the root of the conductive rod to the conductive surface of the conductive member 110

The distance from the root 124b of each conductive rod 124 to the conductive surface 110a of the conductive member 110 may be longer than the height of the conductive rods 124, while also being less than λm/2. When the distance is λm/2 or more, resonance may occur between the root 124b of each conductive rod 124 and the conductive surface 110a, thus reducing the effect of signal wave containment.

The distance from the root 124b of each conductive rod 124 to the conductive surface 110a of the conductive member 110 corresponds to the spacing between the conductive member 110 and the conductive member 120. For example, when a signal wave of 76.5±0.5 GHz (which belongs to the millimeter band or the extremely high frequency band) propagates in the waveguide, the wavelength of the signal wave is in the range from 3.8934 mm to 3.9446 mm. Therefore, λm equals 3.8934 mm in this case, so that the spacing between the conductive member 110 and the conductive member 120 may be designed to be less than a half of 3.8934 mm. So long as the conductive member 110 and the conductive member 120 realize such a narrow spacing while being disposed opposite from each other, the conductive member 110 and the conductive member 120 do not need to be strictly parallel. Moreover, when the spacing between the conductive member 110 and the conductive member 120 is less than λm/2, a whole or a part of the conductive member 110 and/or the conductive member 120 may be shaped as a curved surface. On the other hand, the conductive members 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

In the example shown in FIG. 20A, the conductive surface 120a is illustrated as a plane; however, example embodiments of the present disclosure are not limited thereto. For example, as shown in FIG. 20B, the conductive surface 120a may be the bottom parts of faces each of which has a cross section similar to a U-shape or a V-shape. The conductive surface 120a will have such a structure when each conductive rod 124 or the waveguide 122 is shaped with a width which increases toward the root. Even with such a structure, the device shown in FIG. 20B can function as the waveguiding device according to an example embodiment of the present disclosure so long as the distance between the conductive surface 110a and the conductive surface 120a is less than a half of the wavelength λm.

(3) distance L2 from the leading end of the conductive rod to the conductive surface

The distance L2 from the leading end 124a of each conductive rod 124 to the conductive surface 110a is set to less than λm/2. When the distance is λm/2 or more, a propagation mode where electromagnetic waves reciprocate between the leading end 124a of each conductive rod 124 and the conductive surface 110a may occur, thus no longer being able to contain an electromagnetic wave. Note that, among the plurality of conductive rods 124, at least those which are adjacent to the waveguide 122 do not have their leading ends in electrical contact with the conductive surface 110a. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface.

(4) arrangement and shape of conductive rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110a. Therefore, the width of the interspace between rods may be appropriately determined depending on other design parameters. Although there is no clear lower limit to the width of the interspace between rods, for manufacturing ease, it may be e.g. λm/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straight-forward regularity. The conductive rods 124 may also vary in shape and size depending on the position on the conductive member 120.

The surface 125 of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to the waveguiding device of the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124 (in particular, those conductive rods 124 which are adjacent to the waveguide 122), i.e., the length from the root 124b to the leading end 124a, may be set to a value which is shorter than the distance (i.e., less than λm/2) between the conductive surface 110a and the conductive surface 120a, e.g., λo/4.

(5) width of the waveguide face

The width of the waveguide face 122a of the waveguide 122, i.e., the size of the waveguide face 122a along a direction which is orthogonal to the direction that the waveguide 122 extends, may be set to less than λm/2 (e.g. λo/8). If the width of the waveguide face 122a is λm/2 or more, resonance will occur along the width direction, which will prevent any WRG from operating as a simple transmission line.

(6) height of the waveguide

The height (i.e., the size along the Z direction in the example shown in the figure) of the waveguide 122 is set to less than λm/2. The reason is that, if the distance is λm/2 or more, the distance between the root 124b of each conductive rod 124 and the conductive surface 110a will be λo/2 or more.

(7) distance L1 between the waveguide face and the conductive surface

The distance L1 between the waveguide face 122a of the waveguide 122 and the conductive surface 110a is set to less than λm/2. If the distance is λm/2 or more, resonance will occur between the waveguide face 122a and the conductive surface 110a, which will prevent functionality as a waveguide. In one example, the distance L1 is λm/4 or less. In order to ensure manufacturing ease, when an electromagnetic wave in the extremely high frequency range is to propagate, the distance L1 is preferably λm/16 or more, for example.

The lower limit of the distance L1 between the conductive surface 110a and the waveguide face 122a and the lower limit of the distance L2 between the conductive surface 110a and the leading end 124a of each conductive rod 124 depends on the machining precision, and also on the precision when assembling the two upper/lower conductive members 110 and 120 so as to be apart by a constant distance. When a pressing technique or an injection technique is used, the practical lower limit of the aforementioned distance is about 50 micrometers (μm). In the case of using MEMS (Micro-Electro-Mechanical System) technology to make a product in e.g. the terahertz range, the lower limit of the aforementioned distance is about 2 to about 3 μm.

Next, variants of waveguide structures including the waveguide 122, the conductive members 110 and 120, and the plurality of conductive rods 124 will be described. The following variants are applicable to the WRG structure in any place in example embodiments of the present disclosure.

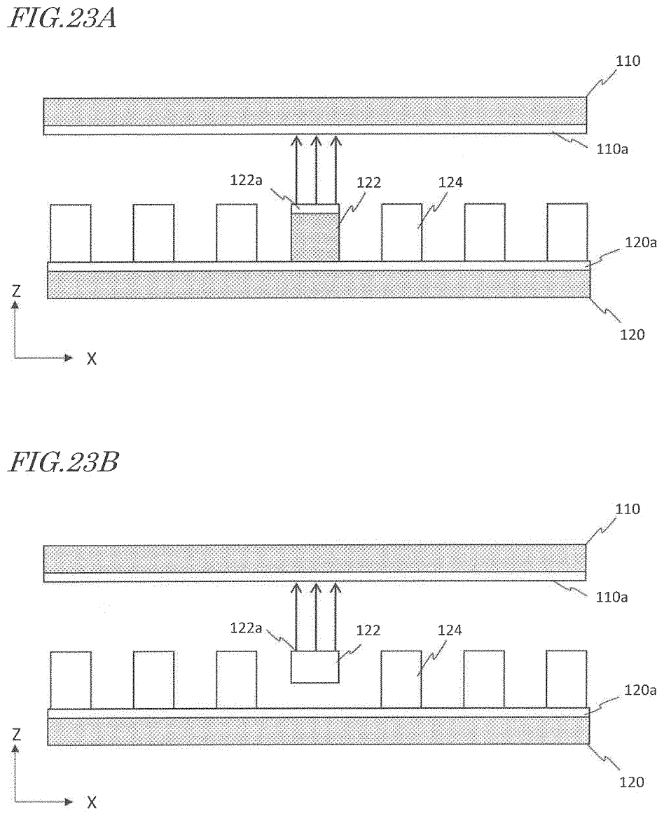

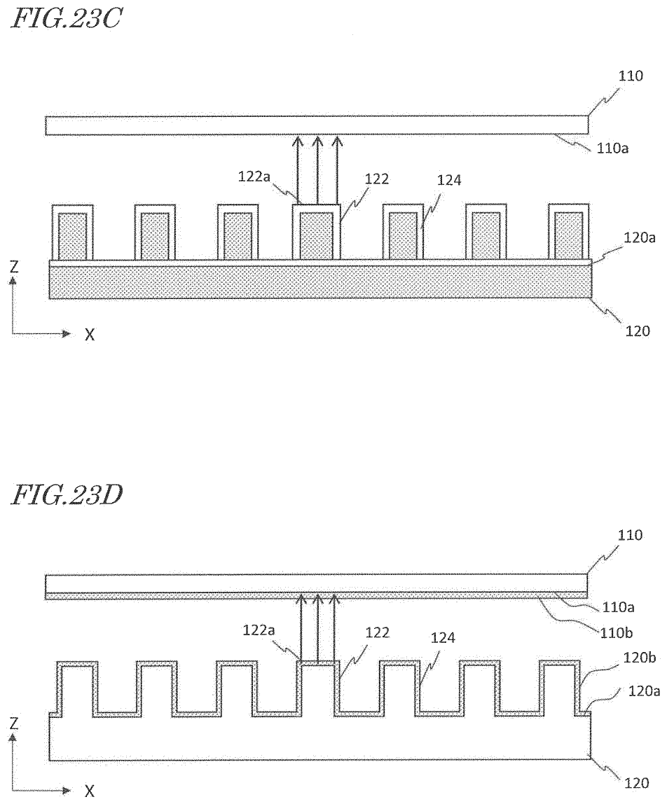

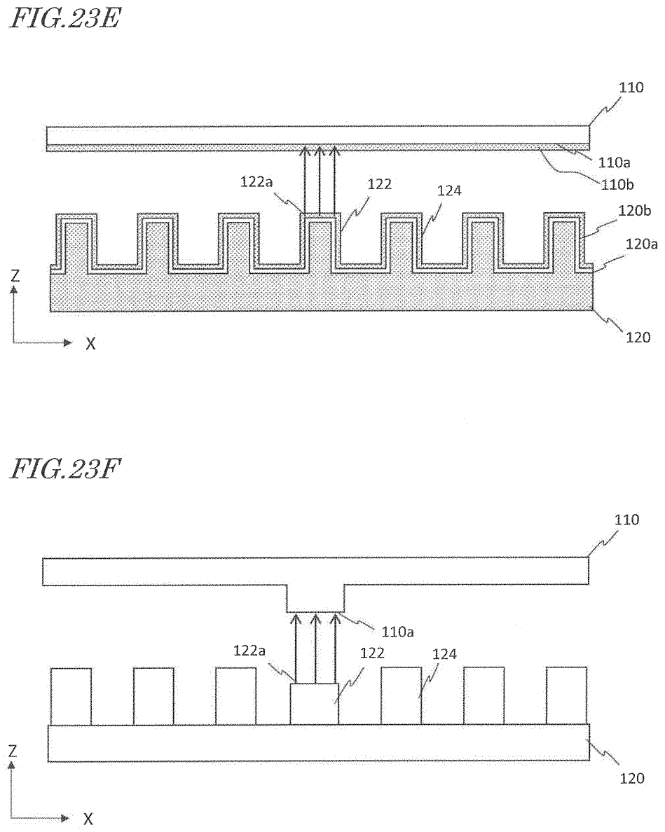

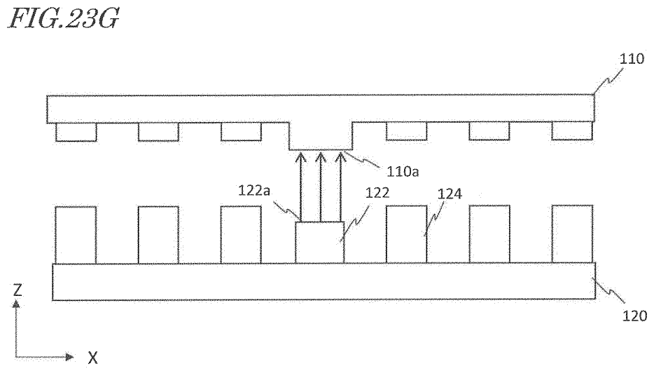

FIG. 23A is a cross-sectional view showing an exemplary structure in which only the waveguide face 122a, defining an upper face of the waveguide 122, is electrically conductive, while any portion of the waveguide 122 other than the waveguide face 122a is not electrically conductive. Both of the conductive members 110 and 120 alike are only electrically conductive at their surface that has the waveguide 122 provided thereon (i.e., the conductive surface 110a, 120a), while not being electrically conductive in any other portions. Thus, each of the waveguide 122, the conductive member 110, and the conductive member 120 does not need to be electrically conductive.

FIG. 23B is a diagram showing a variant in which the waveguide 122 is not formed on the conductive member 120. In this example, the waveguide 122 is fixed to a supporting member (e.g., the inner wall of the housing) that supports the conductive members 110 and 120. A gap exists between the waveguide 122 and the conductive member 120. Thus, the waveguide 122 does not need to be connected to the conductive member 120.

FIG. 23C is a diagram showing an exemplary structure where the conductive member 120, the waveguide 122, and each of the plurality of conductive rods 124 are composed of a dielectric surface that is coated with an electrically conductive material such as a metal. The conductive member 120, the waveguide 122, and the plurality of conductive rods 124 are connected to one another via the electrical conductor. On the other hand, the conductive member 110 is made of an electrically conductive material such as a metal.

FIG. 23D and FIG. 23E are diagrams each showing an exemplary structure in which dielectric layers 110b and 120b are respectively provided on the outermost surfaces of conductive members 110 and 120, a waveguide 122, and conductive rods 124. FIG. 23D shows an exemplary structure in which the surface of metal conductive members, which are electrical conductors, are covered with a dielectric layer. FIG. 23E shows an example where the conductive member 120 is structured so that the surface of members which are composed of a dielectric, e.g., resin, is covered with an electrical conductor such as a metal, this metal layer being further coated with a dielectric layer. The dielectric layer that covers the metal surface may be a coating of resin or the like, or an oxide film of passivation coating or the like which is generated as the metal becomes oxidized.

The dielectric layer on the outermost surface will allow losses to be increased in the electromagnetic wave propagating through the WRG waveguide, but is able to protect the conductive surfaces 110a and 120a (which are electrically conductive) from corrosion. It also prevents influences of a DC voltage, or an AC voltage of such a low frequency that it is not capable of propagation on certain WRG waveguides.

FIG. 23F is a diagram showing an example where the height of the waveguide 122 is lower than the height of the conductive rods 124, and the portion of the conductive surface 110a of the conductive member 110 that is opposed to the waveguide face 122a protrudes toward the waveguide 122. Even such a structure will operate in a similar manner to the above-described example embodiment, so long as the ranges of dimensions depicted in FIG. 22 are satisfied.

FIG. 23G is a diagram showing an example where, further in the structure of FIG. 23F, portions of the conductive surface 110a that are opposed to the conductive rods 124 protrude toward the conductive rods 124. Even such a structure will operate in a similar manner to the above-described example embodiment, so long as the ranges of dimensions depicted in FIG. 22 are satisfied. Instead of a structure in which the conductive surface 110a partially protrudes, a structure in which the conductive surface 110a is partially dented may be adopted.

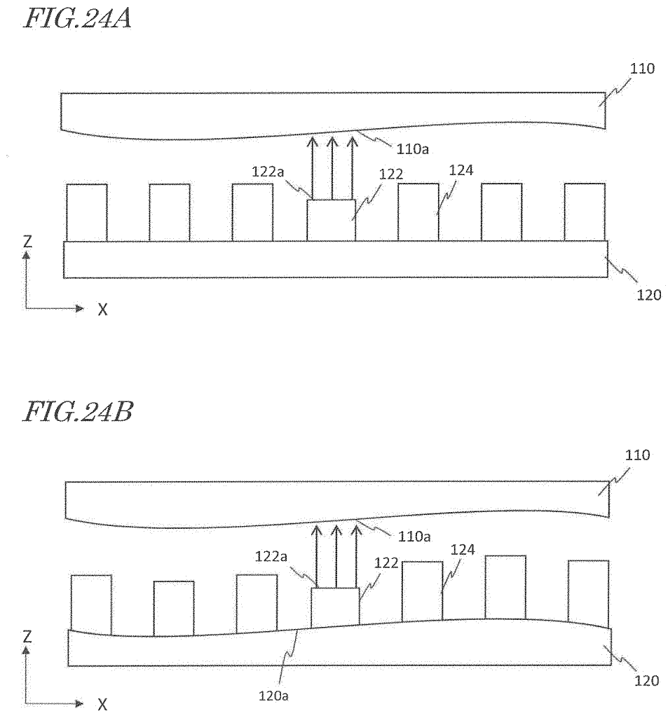

FIG. 24A is a diagram showing an example where a conductive surface 110a of the conductive member 110 is shaped as a curved surface. FIG. 24B is a diagram showing an example where also a conductive surface 120a of the conductive member 120 is shaped as a curved surface. As demonstrated by these examples, the conductive surfaces 110a and 120a may not be shaped as planes, but may be shaped as curved surfaces. A conductive member having a conductive surface which is a curved surface is also qualifies as a conductive member having a “plate shape”.

In the waveguiding device 100 of the above-described construction, a signal wave of the operating frequency is unable to propagate in the space between the surface 125 of the artificial magnetic conductor and the conductive surface 110a of the conductive member 110, but propagates in the space between the waveguide face 122a of the waveguide 122 and the conductive surface 110a of the conductive member 110. Unlike in a hollow waveguide, the width of the waveguide 122 in such a waveguide structure does not need to be equal to or greater than a half of the wavelength of the electromagnetic wave to propagate. Moreover, the conductive member 110 and the conductive member 120 do not need to be electrically interconnected by a metal wall that extends along the thickness direction (i.e., in parallel to the YZ plane).

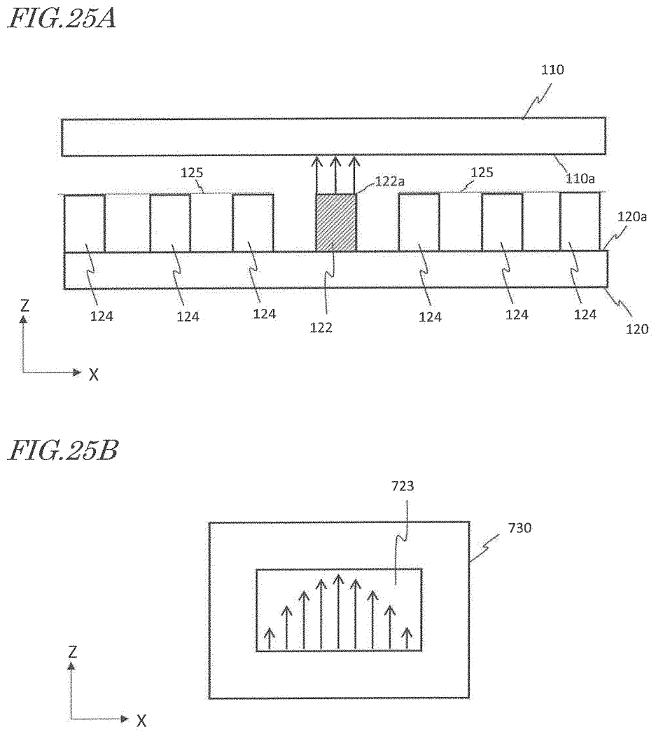

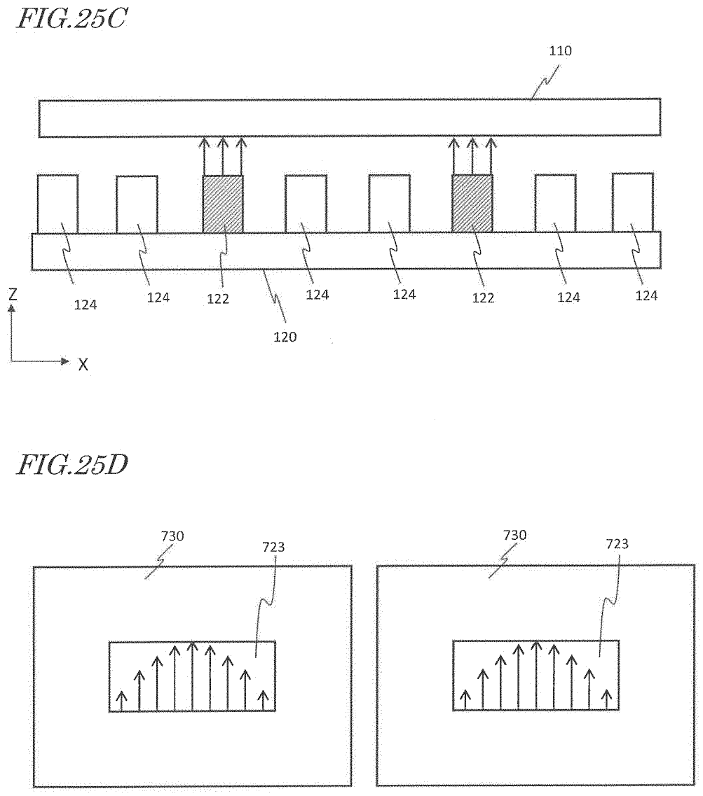

FIG. 25A schematically shows an electromagnetic wave that propagates in a narrow space, i.e., a gap between the waveguide face 122a of the waveguide 122 and the conductive surface 110a of the conductive member 110. Three arrows in FIG. 25A schematically indicate the orientation of an electric field of the propagating electromagnetic wave. The electric field of the propagating electromagnetic wave is perpendicular to the conductive surface 110a of the conductive member 110 and to the waveguide face 122a.

On both sides of the waveguide 122, stretches of artificial magnetic conductor that are created by the plurality of conductive rods 124 are present. An electromagnetic wave propagates in the gap between the waveguide face 122a of the waveguide 122 and the conductive surface 110a of the conductive member 110. FIG. 25A is schematic, and does not accurately represent the magnitude of an electromagnetic field to be actually created by the electromagnetic wave. A part of the electromagnetic wave (electromagnetic field) propagating in the space over the waveguide face 122a may have a lateral expanse, to the outside (i.e., toward where the artificial magnetic conductor exists) of the space that is delineated by the width of the waveguide face 122a. In this example, the electromagnetic wave propagates in a direction (i.e., the Y direction) which is perpendicular to the plane of FIG. 25A. As such, the waveguide 122 does not need to extend linearly along the Y direction, but may include a bend(s) and/or a branching portion(s) not shown. Since the electromagnetic wave propagates along the waveguide face 122a of the waveguide 122, the direction of propagation would change at a bend, whereas the direction of propagation would ramify into plural directions at a branching portion.

In the waveguide structure of FIG. 25A, no metal wall (electric wall), which would be indispensable to a hollow waveguide, exists on both sides of the propagating electromagnetic wave. Therefore, in the waveguide structure of this example, “a constraint due to a metal wall (electric wall)” is not included in the boundary conditions for the electromagnetic field mode to be created by the propagating electromagnetic wave, and the width (size along the X direction) of the waveguide face 122a is less than a half of the wavelength of the electromagnetic wave.

For reference, FIG. 25B schematically shows a cross section of a hollow waveguide 730. With arrows, FIG. 25B schematically shows the orientation of an electric field of an electromagnetic field mode (TE₁₀) that is created in the internal space 723 of the hollow waveguide 730. The lengths of the arrows correspond to electric field intensities. The width of the internal space 723 of the hollow waveguide 730 needs to be set to be broader than a half of the wavelength. In other words, the width of the internal space 723 of the hollow waveguide 730 cannot be set to be smaller than a half of the wavelength of the propagating electromagnetic wave.

FIG. 25C is a cross-sectional view showing an implementation where two waveguides 122 are provided on the conductive member 120. Thus, an artificial magnetic conductor that is created by the plurality of conductive rods 124 exists between the two adjacent waveguides 122. More accurately, stretches of artificial magnetic conductor created by the plurality of conductive rods 124 are present on both sides of each waveguide 122, such that each waveguide 122 is able to independently propagate an electromagnetic wave.

For reference's sake, FIG. 25D schematically shows a cross section of a waveguiding device in which two hollow waveguides 730 are placed side-by-side. The two hollow waveguides 730 are electrically insulated from each other. Each space in which an electromagnetic wave is to propagate needs to be surrounded by a metal wall that defines the respective hollow waveguide 730. Therefore, the interval between the internal spaces 723 in which electromagnetic waves are to propagate cannot be made smaller than a total of the thicknesses of two metal walls. Usually, a total of the thicknesses of two metal walls is longer than a half of the wavelength of a propagating electromagnetic wave. Therefore, it is difficult for the interval between the hollow waveguides 730 (i.e., interval between their centers) to be shorter than the wavelength of a propagating electromagnetic wave. Particularly for electromagnetic waves of wavelengths in the extremely high frequency range (i.e., electromagnetic wave wavelength: 10 mm or less) or even shorter wavelengths, a metal wall which is sufficiently thin relative to the wavelength is difficult to be formed. This presents a cost problem in commercially practical implementation.

On the other hand, a waveguiding device 100 including an artificial magnetic conductor can easily realize a structure in which waveguides 122 are placed close to one another. Thus, such a waveguiding device 100 can be suitably used in an antenna array that includes plural antenna elements in a close arrangement.

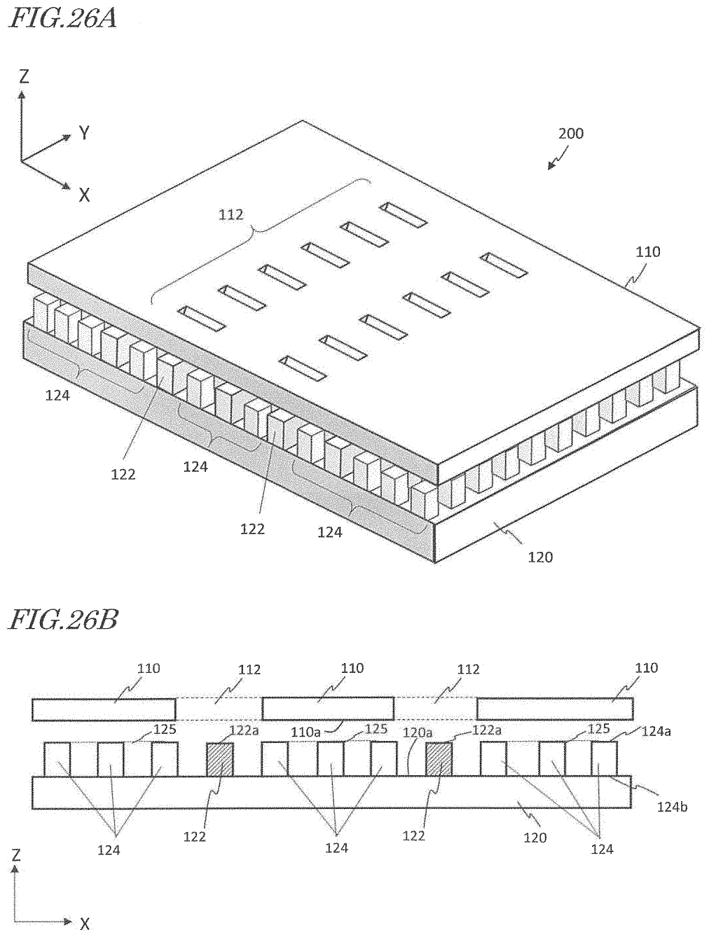

FIG. 26A is a perspective view schematically showing a portion of the construction of a slot antenna array 200 as an example of an antenna device utilizing the aforementioned waveguide structure. FIG. 26B is a diagram showing schematically showing a portion of a cross section taken parallel to an XZ plane which passes through the centers of two adjacent slots 112 along the X direction of the slot antenna array 200. In the slot antenna array 200, the first conductive member 110 has a plurality of slots 112 arranged along the X direction and the Y direction. In this example, the plurality of slots 112 include two slot rows, each slot row including six slots 112 arranged at an equal interval along the Y direction. On the conductive member 120, two waveguides 122 extending along the Y direction are provided. Each waveguide 122 has an electrically-conductive waveguide face 122a opposing one slot row. In a region between the two waveguides 122 and in regions outside of the two waveguides 122, a plurality of conductive rods 124 are disposed. These conductive rods 124 constitute an artificial magnetic conductor.

From a transmission circuit not shown, an electromag-netic wave is supplied to a waveguide extending between the waveguide face 122a of each waveguide 122 and the conductive surface 110a of the conductive member 110. Among the plurality of slots 112 arranged along the Y direction, the distance between the centers of two adjacent slots 112 is designed so as to be equal in value to the wavelength of an electromagnetic wave propagating in the waveguide, for example. As a result of this, electromagnetic waves with an equal phase can be radiated from the six slots 112 arranged along the Y direction.

The slot antenna array 200 shown in FIG. 26A and FIG. 26B is an antenna array in which the plurality of slots 112 serve as antenna elements (radiating elements). With such construction of the slot antenna array 200, the interval between the centers of antenna elements can be made shorter than a wavelength λo in free space of an electromagnetic wave propagating through the waveguide, for example. Horns may be provided for the plurality of slots 112. By providing horns, radiation characteristics or reception characteristics can be improved.

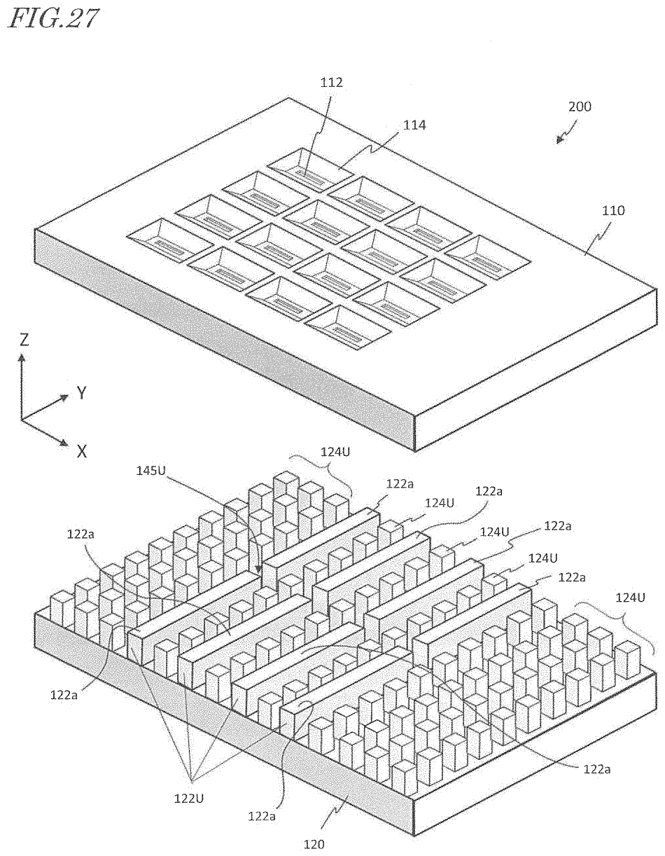

FIG. 27 is a perspective view schematically showing a portion of the structure of a slot antenna array 200 which has horn 114 for each slot 112. The slot antenna array 200 includes: a conductive member 110 having a plurality of slots 112 and a plurality of horns 114 arranged in a two-dimensional array; and a conductive member 120 on which a plurality of waveguides 122U and a plurality of conductive rods 124U are arranged. FIG. 27 is illustrated so that the spacing between the conductive members 110 and 120 is exaggerated. The plurality of slots 112 in the conductive member 110 are arranged along a first direction which extends along the conductive surface 110a of the conductive member 110 (the Y direction) and a second direction (the X direction) which intersects (e.g., orthogonal in this example) the first direction. FIG. 27 also shows a port (throughhole) 145U that is disposed in the center of each waveguide 122U. The choke structures which may be disposed at both ends of the waveguide 122U are omitted from illustration. Although the present example embodiment illustrates that there are four waveguides 122U, the number of waveguides 122U may be arbitrary. In the present example embodiment, each waveguide 122U is split into two portions at the position of the port 145U in the middle.

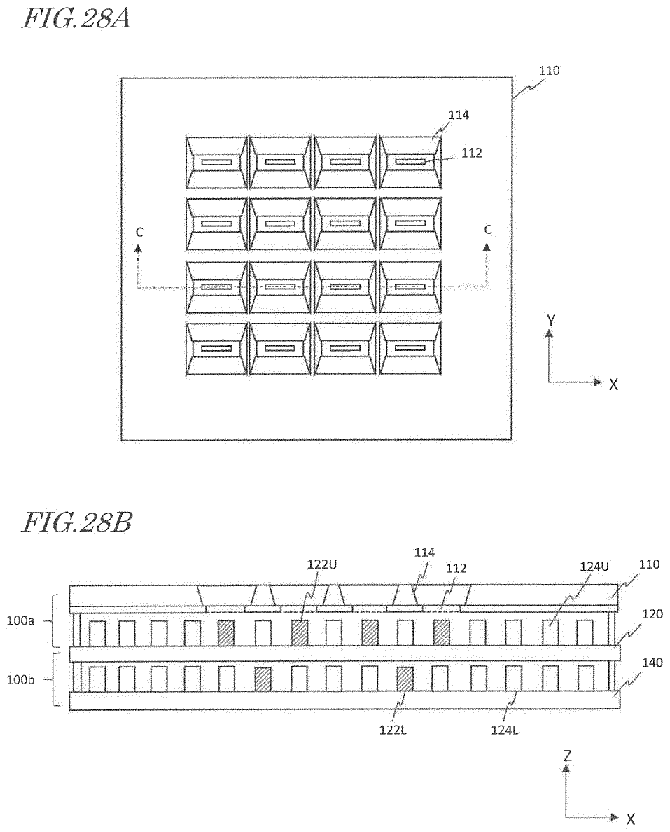

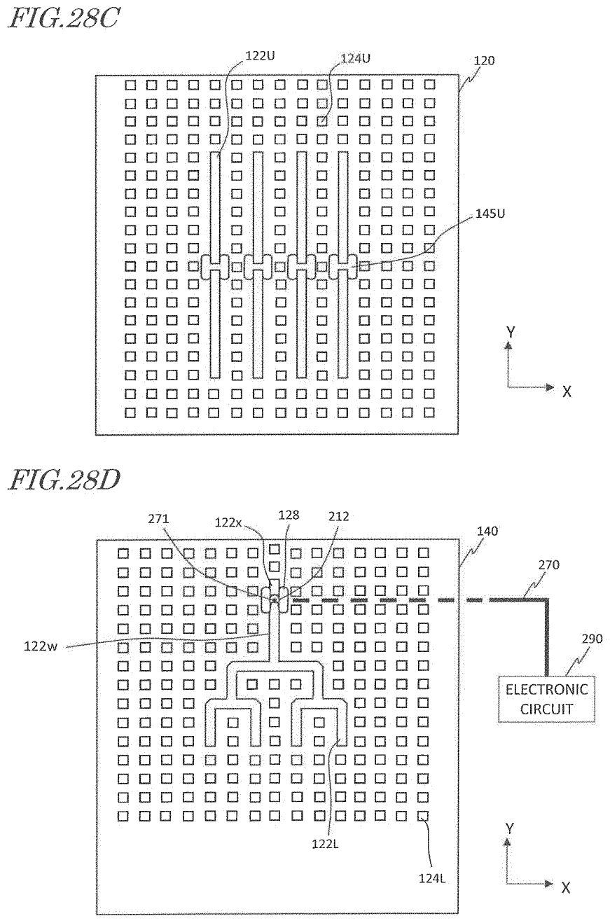

FIG. 28A is an upper plan view showing an antenna array 200 in which 16 slots are arranged in four rows and four columns as shown in FIG. 27, as viewed along the Z direction. FIG. 28B is a cross-sectional view taken along line C-C in FIG. 28A. The conductive member 110 in the antenna array 200 includes the plurality of horns 114, which are provided respectively corresponding to the plurality of slots 112. Each of the plurality of horns 114 includes four electrically conductive walls surrounding the slot 112. With such horns 114, directivity can be improved.

In the illustrated antenna array 200, a first waveguiding device 100a and a second waveguiding device 100b are layered, the first waveguiding device 100a including first waveguides 122U that directly couple to the slots 112, and the second waveguiding device 100b including a second waveguide 122L that couples to the waveguides 122U on the first waveguiding device 100a. The waveguide 122L and the conductive rods 124L of the second waveguiding device 100b are disposed on a conductive member 140. The second waveguiding device 100b basically has a similar construction to the construction of the first waveguiding device 100a.

As shown in FIG. 28A, the conductive member 110 includes a plurality of slots 112 that are arranged along the first direction (the Y direction) and the second direction (the X direction) which is orthogonal to the first direction. The waveguide faces 122a of the plurality of waveguides 122U extend along the Y direction are opposed to four slots that are arranged side by side along the Y direction, among the plurality of slots 112. Although this example illustrates that the conductive member 110 has 16 slots 112 that are arranged in four rows and four columns, the number and arrangement of slots 112 are not limited to this example. Without being limited to the example where the waveguides 122U are opposed to all slots among the plurality of slots 112 that are arranged side by side along the Y direction, there may be waveguides 122U opposed to at least two adjacent slots along the Y direction. The interval between the centers of two adjacent waveguide faces 122a along the X direction may be set to be shorter than the wavelength λo, and more preferably shorter than the wavelength λo/2, for example.

FIG. 28C is a diagram showing a planar layout of the waveguides 122U on the first waveguiding device 100a. FIG. 28D is a diagram showing a planar layout of the waveguide 122L on the second waveguiding device 100b. As shown in these figures, the waveguides 122U on the first waveguiding device 100a extend in linear shapes (stripes), without having any branching portions or bends. On the other hand, the waveguide 122L on the second waveguiding device 100b includes both of branching portions and bends.

The waveguides 122U on the first waveguiding device 100a couple to the waveguide 122L on the second waveguiding device 100b via the ports (apertures) 145U of the conductive member 120. In other words, an electromagnetic wave which has propagated along the waveguide 122L on the second waveguiding device 100b passes through the port 145U to reach the waveguide 122U on the first waveguiding device 100a, thereby being able to propagate through the waveguide 122U on the first waveguiding device 100a. In this case, each slot 112 functions as an antenna element to allow an electromagnetic wave which has propagated through the waveguide to be radiated into space. Conversely, when an electromagnetic wave which has propagated in space impinges on a slot 112, the electromagnetic wave couples to the waveguide 122U on the first waveguiding device 100a that lies immediately under that slot 112, and propagates along the waveguide 122U on the first waveguiding device 100a. An electromagnetic wave which has propagated along a waveguide 122U of the first waveguiding device 100a may also pass through the port 145U to reach the ridge 122L on the second waveguiding device 100b, and propagate along the ridge 122L.

As shown in FIG. 28D, the waveguide 122L of the second waveguiding device 100b includes one stem-like portion and four branch-like portions which branch out from the stem-like portion. The stem-like portion of the waveguide 122L extends along the Y direction, and is split into a first ridge 122w and a second ridge 122x. At the position of a gap between the first ridge 122w and the second ridge 122x, the conductive member 140 has a throughhole 212. In the throughhole 212, a coaxial cable 270 or a connector that is connected to the coaxial cable 270 is inserted. The core 271 of the coaxial cable 270 or the connector is connected to an end face of the first ridge 122w or the second ridge 122x. The connection structure between the core 271 and the waveguide 122L is similar to the connection structure which has been described with reference to FIG. 1A and FIG. 1B. The coaxial cable 270 is connected to an electronic circuit 290 that generates or receives a radio frequency signal.

Without being limited to a specific position, the electronic circuit 290 may be provided at any arbitrary position. The electronic circuit 290 may be provided on a circuit board which is on the rear surface side (i.e., the lower side in FIG. 28B) of the conductive member 140, for example. Such an electronic circuit may include a microwave integrated circuit, e.g. an MMIC (Monolithic Microwave Integrated Circuit) that generates or receives millimeter waves, for example. In addition to the microwave integrated circuit, the electronic circuit 290 may further include another circuit, e.g., a signal processing circuit. Such a signal processing circuit may be configured to execute various processes that are necessary for the operation of a radar system that includes an antenna device, for example. The electronic circuit 290 may include a communication circuit. The communication circuit may be configured to execute various processes that are necessary for the operation of a communication system that includes an antenna device.

Note that a structure for connecting an electronic circuit to a waveguide is disclosed in, for example, US Patent Publication No. 2018/0351261, US Patent Publication No. 2019/0006743, US Patent Publication No. 2019/0139914, US Patent Publication No. 2019/0067780, US Patent Publication No. 2019/0140344, and International Patent Application Publication No. 2018/105513. The entire disclosure of these publications is incorporated herein by reference.

The conductive member 110 shown in FIG. 28A may be called a “radiation layer”. The layer containing the entirety of the conductive member 120, the waveguides 122U, and the conductive rods 124U shown in FIG. 28C may be called an “excitation layer”; and the layer containing the entirety of the conductive member 140, the waveguide 122L, and the conductive rods 124L shown in FIG. 28D may be called a “distribution layer”. Moreover, the “excitation layer” and the “distribution layer” may be collectively called a “feeding layer”. Each of the “radiation layer”, the “excitation layer” and the “distribution layer” can be mass-produced by processing a single metal plate. The radiation layer, the excitation layer, the distribution layer, and any electronic circuitry to be provided on the rear face side of the distribution layer may be produced as a single-module product.

In the antenna array of this example, as can be seen from FIG. 28B, a plate-like radiation layer, excitation layer, and distribution layer are layered, so that, as a whole, a flat panel antenna which is flat and low-profiled is realized. For example, the height (thickness) of a multilayer structure having a cross-sectional construction as shown in FIG. 28B can be made 10 mm or less.

The waveguide 122L shown in FIG. 28D includes one stem-like portion that is connected to the core 271, and four branch-like portions which branch out from the stem-like portion. The four ports 145U are respectively opposed to the upper faces of the leading ends of the four branch-like portions. The distances from the throughhole 212 to the four ports 145U of the conductive member 120 as measured along the waveguide 122L are all equal. Therefore, a signal wave which is input from the throughhole 212 of the conductive member 140 to the waveguide 122L reaches the four ports 145U, which are disposed in the center of the waveguide 122U along the Y direction, all in the same phase. As a result, the four waveguides 122U on the conductive member 120 can be excited in the same phase.

Depending on the application, it is not necessary for all slots 112 functioning as antenna elements to radiate electromagnetic waves in the same phase. The network patterns of the waveguides 122U and 122L in the excitation layer and the distribution layer may be arbitrary, without being limited to what is shown in the figures.

When constructing an excitation layer and a distribution layer, various circuit elements in waveguides can be utilized. Examples thereof are disclosed in U.S. Pat. Nos. 10,042,045, 10,090,600, 10,158,158, International Patent Application Publication No. 2018/207796, International Patent Application Publication No. 2018/207838, and US Patent Publication No. 2019/0074569, for example. The entire disclosure of these publications is incorporated herein by reference.

An antenna device according to an example embodiment of the present disclosure can be suitably used in a radar device or a radar system to be incorporated in moving entities such as vehicles, marine vessels, aircraft, robots, or the like, for example. A radar device would include an antenna device having the waveguiding device according to an example embodiment of the present disclosure and a microwave integrated circuit that is connected to the antenna device. A radar system would include the radar device and a signal processing circuit that is connected to the microwave integrated circuit of the radar device. When an antenna device according to an example embodiment of the present disclosure is combined with a WRG structure which permits downsizing, the area of the face on which the antenna elements are arranged can be reduced as compared to any construction using a conventional hollow waveguide. Therefore, a radar system incorporating the antenna device can be easily installed even in a narrow place. The radar system may be fixed to a road or a building in use, for example. The signal processing circuit may perform a process of estimating the azimuth of an arriving wave based on a signal that is received by a microwave integrated circuit, for example. For example, the signal processing circuit may be configured to execute the MUSIC method, the ESPRIT method, the SAGE method, or other algorithms to estimate the azimuth of the arriving wave, and output a signal indicating the estimation result. Furthermore, the signal processing circuit may be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoC). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory elements (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

An antenna device according to an example embodiment of the present disclosure can also be used in a wireless communication system. Such a wireless communication system would include an antenna device having the waveguiding device according to any of the above example embodiments and a communication circuit (a transmission circuit or a reception circuit) connected to the antenna device. For example, the transmission circuit may be configured to supply, to a waveguide within the antenna device, a signal wave representing a signal for transmission. The reception circuit may be configured to demodulate a signal wave which has been received via the antenna device, and output it as an analog or digital signal.

An antenna device according to an example embodiment of the present disclosure can further be used as an antenna in an indoor positioning system (IPS). An indoor positioning system is able to identify the position of a moving entity, such as a person or an automated guided vehicle (AGV), that is in a building. An antenna device can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of radar systems, communication systems, and various monitoring systems that include a slot array antenna having a WRG structure are disclosed in the specifications of U.S. Pat. Nos. 9,786,995 and 10,027,032, for example. The entire disclosure of these publications is incorporated herein by reference. A slot array antenna according to the present disclosure is applicable to each application example that is disclosed in these publications.

A waveguiding device according to the present disclosure is usable in any technological field that utilizes an antenna. For example, it is available to various applications where transmission/reception of electromagnetic waves of the gigahertz band or the terahertz band is performed. In particular, they may be suitably used in onboard radar systems, various types of monitoring systems, indoor positioning systems, and wireless communication systems, e.g., Massive MIMO, where downsizing is desired.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A method of producing a waveguide-to-coaxial adapter array including a plurality of waveguide-to-coaxial adapters arranged in a two-dimensional array,
the waveguide-to-coaxial adapter array including an electrical conductor including a first surface, a second surface opposite to the first surface, a plurality of throughholes extending from the first surface through to the second surface, to which a plurality of coaxial connectors each including a core are to be connected, and a plurality of electrically conductive rods protruding from the second surface and being provided around the plurality of throughholes;
the production method comprising:
applying solder paste to an inner surface of each of the plurality of throughholes;
inserting the plurality of coaxial connectors respectively in the plurality of throughholes from the first surface of the electrical conductor, so that the cores of the plurality of coaxial connectors respectively become located at the inner surfaces of the plurality of throughholes;
inserting one or more fixtures including a flat surface in the plurality of throughholes from the second surface of the electrical conductor, so that the flat surface of the one or more fixtures is in contact with the cores of the plurality of coaxial connectors and that the cores of the plurality of coaxial connectors are respectively held against the inner surfaces of the plurality of throughholes;
connecting the cores of the plurality of coaxial connectors respectively to the inner surfaces of the plurality of throughholes by melting the solder paste applied to the inner surfaces of the plurality of throughholes; and
after the connecting of the cores, disengaging the one or more fixtures from the inner surfaces of the plurality of throughholes, to obtain the waveguide-to-coaxial adapter array.

2. The method of producing a waveguiding device of claim 1, wherein
at least one of the one or more fixtures includes a plurality of first portions and a second portion, the second portion being continuous with the plurality of first portions and extending in a direction; and
during the inserting of the one or more fixtures, each of the plurality of first portions is inserted in a corresponding one of the plurality of throughholes.

3. The method of producing a waveguide-to-coaxial adapter array of claim 2, wherein
the applying of solder paste is performed before the inserting of the plurality of coaxial connectors respectively in the plurality of throughholes.

4. A method of producing an antenna array, comprising connecting a waveguide-to-coaxial adapter array which is produced by the method of claim 1 and another electrical conductor including a plurality of horns, to obtain an antenna array.

5. A method of producing an antenna array, comprising connecting a waveguide-to-coaxial adapter array which is produced by the method of claim 1 and another electrical conductor including a plurality of horns, to obtain an antenna array; wherein
the applying of solder paste is performed before the inserting of the plurality of coaxial connectors respectively in the plurality of throughholes;
at least one of the one or more fixtures includes a plurality of first portions and a second portion, the second portion being continuous with the plurality of first portions and extending in a direction; and
during the inserting of the one or more fixtures, each of the plurality of first portions is inserted in a corresponding one of the plurality of throughholes.

6. A method of producing a waveguiding device,
the waveguiding device including:
a first electrical conductor;
a second electrical conductor including a first surface, a second surface opposite to the first surface, a plurality of throughholes extending from the first surface through to the second surface, a plurality of waveguides protruding from the second surface, and a plurality of electrically conductive rods protruding from the second surface and being provided around the plurality of throughholes and the plurality of waveguides, the second surface being opposed to a surface of the first electrical conductor; and
a plurality of coaxial connectors respectively connected to the plurality of throughholes of the second electrical conductor; wherein
each of the plurality of coaxial connectors includes a core; and
ends of the plurality of waveguides are respectively continuous with the inner surfaces of the plurality of throughholes;
the method comprising:
applying solder paste to the ends of the plurality of waveguides;
inserting the plurality of coaxial connectors respectively in the plurality of throughholes from the first surface of the second electrical conductor, so that the cores of the plurality of coaxial connectors respectively become located at the ends of the plurality of waveguides;
inserting one or more fixtures including a flat surface in the plurality of throughholes from the second surface of the second electrical conductor, so that the flat surface of the one or more fixtures is in contact with the cores of the plurality of coaxial connectors and so that the cores of the plurality of coaxial connectors are respectively held against the ends of the plurality of waveguides;
connecting the cores of the plurality of coaxial connectors respectively to the ends of the plurality of waveguides by melting the solder paste applied to the ends of the plurality of waveguides; and
after the connecting of the cores, disengaging the one or more fixtures from the ends of the plurality of waveguides, to obtain the second electrical conductor.

7. The method of producing a waveguiding device of claim 6, wherein
at least one of the one or more fixtures includes a plurality of first portions and a second portion, the second portion being continuous with the first portions and extending in a direction;
and
during the inserting of the one or more fixtures, each of the plurality of first portions is inserted in a corresponding one of the plurality of throughholes.

8. The method of producing a waveguiding device of claim 6, wherein the applying of the solder paste is performed before the inserting of the plurality of coaxial connectors respectively in the plurality of throughholes.

9. The method of producing a waveguiding device of claim 6, wherein the first electrical conductor includes a plurality of antenna elements to perform at least one of transmission and reception of an electromagnetic wave.

10. The method of producing a waveguiding device of claim 6, wherein
at least one of the one or more fixtures includes a plurality of first portions and a second portion, the second portion being continuous with the first portions and extending in a direction; and
during the inserting of the one or more fixtures, each of the plurality of first portions is inserted in a corresponding one of the plurality of throughholes;
the applying of the solder paste is performed before the inserting of the plurality of coaxial connectors respectively in the plurality of throughholes; and
the first electrical conductor includes a plurality of antenna elements to perform at least one of transmission and reception of an electromagnetic wave.
